(19) United States
(12) Patent Application Publication
(10) Pub. No.: US 2025/0301354 A1
(43) Pub. Date: Sep. 25, 2025

(54) COMMUNICATION APPARATUS AND COMMUNICATION METHOD FOR COLLABORATIVE WIRELESS LOCAL AREA NETWORK SENSING

(71) Applicant: Panasonic Intellectual Property Corporation of America, Torrance, CA (US)

(72) Inventors: Rajat PUSHKARNA, Singapore (SG); Rojan CHITRAKAR, Singapore (SG); Yoshio URABE, Nara (JP); Hiroyuki MOTOZUKA, Kanagawa (JP)

(21) Appl. No.: 18/860,484

(22) PCT Filed: Mar. 28, 2023
(86) PCT No.: PCT/SG2023/050203

§ 371 Date: Oct. 25, 2024

(30) Foreign Application Priority Data
Apr. 29, 2022 (SG) 10202204647Q

(51) Int. Cl. H04W 24/10; H04W 74/0816; H04W 84/12

(52) U.S. Cl. CPC H04W 24/10; H04W 74/0816; H04W 84/12

(57) ABSTRACT

The present disclosure provides a receiving communication apparatus, a transmitting communication apparatus and an initiating communication apparatus and communication methods for collaborative wireless local area network sensing, the receiving communication apparatus comprising: a receiver which, in operation, receives, from a transmitting communication apparatus, a sounding signal, wherein the transmitting communication apparatus is configured to perform a first channel measurement with an initiating communication apparatus; and circuitry, which, in operation, is configured to perform a second channel measurement with the transmitting communication apparatus upon receiving the sounding signal.

### TECHNICAL FIELD

The present disclosure relates to communication apparatuses and methods for wireless local rea network sensing (WLAN), and more particularly for collaborative wireless local area network sensing.

### BACKGROUND

A wireless local area network (WLAN) sensing can be performed either by one-to-one sensing which involves one initiator and one responder and extends it to multiple responders, or by collaborative sensing where multiple WiFi devices can be used collaboratively to perform sensing. Collaborative sensing can increase sensing area and increases sensing dimension and achieve benefits of diversity of transmission and reception.

However, detailed procedure and signalling have not specified in the current 11bf draft spec. In addition, variety of scenarios for collaborative sensing, which may be initiated by access point (AP) or non-AP stations (STAs), should be supported.

There is thus a need for communication apparatuses and methods for collaborative WLAN sensing that provide feasible technical solutions to address the issues, more particularly, to realize a collaborative WLAN sensing that provides signalling to support AP initiated sensing scenarios and non-AP initiated sensing scenarios.

Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for collaborative sounding procedure in context of WLAN.

In a first aspect, the present disclosure provides a receiving communication apparatus, comprising: a receiver, which, in operation, receives, from a transmitting communication apparatus, a sounding signal, wherein the transmitting communication apparatus is configured to perform a first channel measurement with an initiating communication apparatus; and circuitry, which, in operation, is configured to perform a second channel measurement with the transmitting communication apparatus upon receiving the sounding signal.

In a second aspect, the present disclosure provides transmitting communication apparatus, comprising: circuitry, which, in operation, is configured to perform a first channel measurement with an initiating communication apparatus and generate a sounding signal; and a transmitter, which, in operation, transmits the sounding signal to a receiving communication apparatus, wherein the receiving communication apparatus receives the sounding signal and performs a second channel measurement with the transmitting communication apparatus.

In a third aspect, the present disclosure provides an initiating communication apparatus, comprising: circuitry, which, in operation, generate a request signal; and a transmitter, which, in operation, transmits the request signal to a transmitting communication apparatus, wherein the transmitting communication apparatus is configured to perform a first channel measurement with the initiating communication apparatus upon receiving the request signal and a receiving communication is configured to perform a second channel measurement with the transmitting communication apparatus upon receiving a sounding signal from the transmitting communication apparatus.

In a fourth aspect, the present disclosure provides a communication method implemented by a receiving communication apparatus, comprising: receiving, from a transmitting communication apparatus, a sounding signal, wherein the transmitting communication apparatus is configured to perform a first channel measurement with an initiating communication apparatus; and performing a second channel measurement with the transmitting communication apparatus based on the sounding signal.

In a fifth aspect, the present disclosure provides a communication method implemented by a transmitting communication apparatus, comprising: performing a first channel measurement with an initiating communication apparatus and generate a sounding signal; and transmitting the sounding signal to a receiving communication apparatus, wherein the receiving communication apparatus receives the sounding signal and performs a second channel measurement with the transmitting communication apparatus.

In a sixth aspect, the present disclosure provides a communication method implemented by an initiating communication apparatus, comprising: generating a request signal; and transmitting the request signal to a transmitting communication apparatus, wherein the transmitting communication apparatus is configured to perform a first channel measurement with the initiating communication apparatus upon receiving the request signal and a receiving communication apparatus is configured to perform a second channel measurement with the transmitting communication apparatus upon receiving a sounding signal from the transmitting communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram illustrating a single-user (SU) communication between an access point (AP) and a station (STA) in a MIMO (multiple-input multiple-output) wireless network.

FIG. 2 depicts a schematic diagram illustrating downlink multi-user (MU) communication between an AP and multiple STAs in a MIMO wireless network.

FIG. 3 depicts a schematic diagram illustrating a trigger-based (TB) uplink MU communication between an AP and multiple STAs in a MIMO wireless network.

FIG. 4 depicts a diagram illustrating one-to-one sensing performed by a sensing initiator and a sensing responder.

FIG. 5 depicts a diagram illustrating collaborative sensing performed by a sensing initiator and two sensing responders.

FIG. 6 depicts a diagram illustrating a procedural flow of a trigger-based (TB) sensing measurement between a sensing initiator and three sensing responders.

FIG. 7 depicts a diagram illustrating a procedural flow of a non-TB sensing measurement between an AP as a sensing responder (sensing receiver) and a non-AP STA as sensing initiator (sensing transmitter).

FIG. 8 depicts a diagram illustrating five different TB sensing measurement examples.

FIG. 9 depicts a flowchart illustrating a procedural flow of a conventional sensing measurement between an AP and two STAs.

FIG. 10 depicts a schematic view of a communication apparatus according to the present disclosure.

FIG. 11 shows a flowchart illustrating a communication method implemented by a receiving communication apparatus according to various embodiments of the present disclosure.

FIG. 12 shows a flowchart illustrating a communication method implemented by a transmitting communication apparatus according to various embodiments of the present disclosure.

FIG. 13 shows a flowchart illustrating a communication method implemented by an initiating communication apparatus according to various embodiments of the present disclosure.

FIG. 14 depicts a diagram illustrating a procedural flow of a collaborative sensing measurement between a sensing initiator and two sensing responders according to various embodiments of the present disclosure.

FIG. 15 depicts a flowchart illustrating an example collaborative sensing procedure with TB sensing measurement between a sensing initiator and two sensing responders according to various embodiments of the present disclosure.

FIG. 16 depicts a flowchart illustrating an example collaborative sensing procedure with non-TB sensing measurement between a sensing initiator and two sensing responders according to various embodiments of the present disclosure.

FIG. 17 depicts a flowchart illustrating an example TB collaborative sensing procedure between a sensing initiator and two sensing responders according to an embodiment of the present disclosure.

FIG. 18 depicts an example of protected Sensing Session Setup Request frame according to a first embodiment of the present disclosure.

FIG. 19 depicts another example of protected Sensing Session Setup Response frame according to the first embodiment of the present disclosure.

FIG. 20 depicts a flowchart illustrating a procedural flow of a sensing measurement instance using a TB sounding procedure between the sensing initiator and the two sensing responders in FIG. 17 according to an embodiment of the present disclosure.

FIG. 21 depicts an example format of a sounding Trigger frame (TF) according to the first embodiment of the present disclosure.

FIG. 22 depicts another example format of a sounding TF according to the first embodiment of the present disclosure.

FIG. 23 depicts an example format of an NDPA (null data packet announcement) frame according to the first embodiment of the present disclosure.

FIG. 24 depicts an example format of a Sensing Measurement Report frame according to the first embodiment of the present disclosure.

FIG. 25 depicts a flowchart illustrating a process implemented by a collaborative sensing receiver according to the first embodiment of the present disclosure.

FIG. 26 depicts a diagram illustrating an example of Trigger-based collaborative sensing procedure with TB sensing measurement between a sensing initiator and two sensing responders according to the first embodiment of present disclosure.

FIG. 27 depicts a flowchart illustrating an example non-TB collaborative sensing procedure between a sensing initiator and two sensing responders according to a second embodiment of the present disclosure.

FIG. 28 depicts a flowchart further illustrating the collaborative sensing procedure according to the second embodiment of the present disclosure.

FIG. 29 depicts a flowchart illustrating a process implemented by an AP according to the second embodiment of the present disclosure.

FIG. 30 depicts a diagram illustrating an example non-TB collaborative sensing procedure between a sensing initiator and two sensing responders according to an implementation of the second embodiment of the present disclosure.

FIG. 31 depicts an example format of a Frame Control field of a NDPA frame according to an alternative implementation of the second embodiment of the present disclosure.

FIG. 32 depicts a flowchart illustrating an example non-TB sensing measurement between a sensing initiator and two sensing responders according to a third embodiment of the present disclosure.

FIG. 33 depicts a flowchart illustrating a process implemented by a non-AP sensing initiator STA according to the third embodiment of the present disclosure.

FIG. 34 depicts a flowchart illustrating an example TB collaborative sensing procedure between a sensing initiator and two sensing responders according to a fourth embodiment of the present disclosure.

FIG. 35 depicts an example protected Sensing Session Setup Request frame according to the fourth embodiment of the present disclosure.

FIG. 36 depicts an example format of an NDPA frame according to the fourth embodiment of the present disclosure.

FIG. 37 depicts a flowchart illustrating an example collaborative sensing procedure between a sensing initiator and three sensing responders according to a fifth embodiment of the present disclosure.

FIG. 38 depicts another example format of a sounding TF according to the fifth embodiment of the present disclosure.

FIG. 39 depicts an example format of a Sensing Measurement Report frame according to the fifth embodiment of the present disclosure.

FIG. 40 depicts an example format of an NDPA frame according to a sixth embodiment of the present disclosure.

FIG. 41 depicts an example format of a Sensing Measurement Report frame according to the sixth embodiment of the present disclosure.

FIG. 42 depicts a block diagram illustrating configuration of a communication apparatus according to various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flow charts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for an aggregated signal sounding procedure, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

According to the present disclosure, an initiating communication apparatus refers to a device which initiates a sensing session and requests for a sensing result. The term “initiating communication apparatus” is used interchangeably with the terms “Initiator”, “Sensing Initiator” in various embodiments below. A Sensing responder or responder is a STA which responds to the initiating communication apparatus which participates in the sensing session.

A transmitting communication apparatus refers to a device (typically a sensing responder) which transmits a sensing signal or feedback response. The term “transmitting communication apparatus” is used interchangeably with the terms “sensing transmitter” and “transmitter”.

A receiving communication apparatus refers to a device which receives a sensing signal or feedback response transmitted by a transmitting communication apparatus and performs a channel measurement based on the sensing signal or feedback response. The term “a receiving communication apparatus” may be used to refer to a sensing receiver or in various embodiments, a collaborative sensing receiver.

Collaborative Sensing Receiver refers to a sensing responder which is capable of performing channel measurement upon receiving sensing measurement PPDU (Physical Layer Protocol Data Unit) from another sensing responder.

In addition, for a sensing responder (e.g., station (STA)) to be a sensing receiver and perform “Sensing responder to Sensing responder” NDP measurement, the sensing responder has to obtain the time and transmission parameter of NDP transmission in advance.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

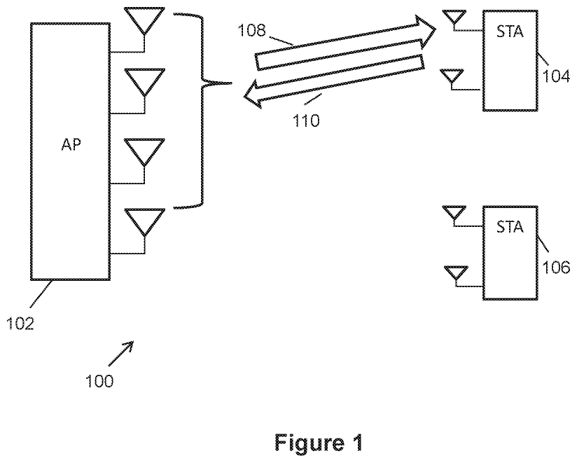

FIG. 1 depicts a schematic diagram illustrating a SU communication 100 between an AP 102 and a STA 104 in a MIMO wireless network. As shown, the MIMO wireless network may include one or more STAs (e.g., STA 104, STA 106, etc.). If the SU communication 100 in a channel is carried out over whole channel bandwidth, it is called full bandwidth SU communication. If the SU communication 100 in a channel is carried out over a part of the channel bandwidth (e.g., one or more 20 MHz subchannels within the channel is punctured), it is called punctured SU communication. In the SU communication 100, the AP 102 transmits multiple space-time streams using multiple antennas (e.g., four antennas as shown in FIG. 1) with all the space-time streams directed to a single communication apparatus, i.e. the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1, in the SU communication 100, the STA 104 may transmit multiple space-time streams using multiple antennas (e.g., two antennas as shown in FIG. 1) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1 enables both uplink and downlink SU transmissions in a MIMO wireless network.

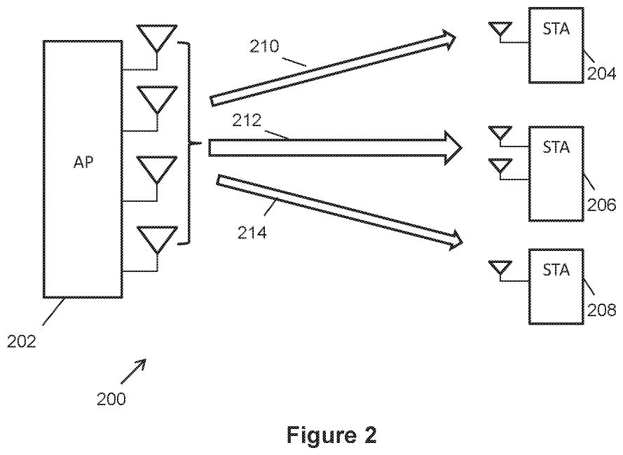

FIG. 2 depicts a schematic diagram illustrating a downlink MU (multiple-user) communication 200 between an AP 202 and multiple STAs 204, 206, 208 in a MIMO wireless network. The MIMO wireless network may include one or more STAs (e.g., STA 204, STA 206, STA 208, etc.). The MU communication 200 can be an OFDMA (orthogonal frequency division multiple access) communications or a MU-MIMO communication. For an OFDMA communication in a channel, the AP 202 transmits multiple streams simultaneously to the STAs 204, 206, 208 in the network at different resource units (RUs) within the channel bandwidth. For a MU-MIMO communication in a channel, the AP 202 transmits multiple streams simultaneously to the STAs 204, 206, 208 at same RU(s) within the channel bandwidth using multiple antennas via spatial mapping or precoding techniques. If the RU(s) at which the OFDMA or MU-MIMO communication occurs occupy whole channel bandwidth, the OFDMA or MU-MIMO communications is called full bandwidth OFDMA or MU-MIMO communications. If the RU(s) at which the OFDMA or MU-MIMO communication occurs occupy a part of channel bandwidth (e.g., one or more 20 MHz subchannel within the channel is punctured), the OFDMA or MU-MIMO communication is called punctured OFDMA or MU-MIMO communications. For example, two space-time streams may be directed to the STA 206, another space-time stream may be directed to the STA 204, and yet another space-time stream may be directed to the STA 208. For the sake of simplicity, the two space-time streams directed to the STA 206 are illustrated as a grouped data transmission arrow 212, the space-time stream directed to the STA 204 is illustrated as a data transmission arrow 210, and the space-time stream directed to the STA 208 is illustrated as a data transmission arrow 214.

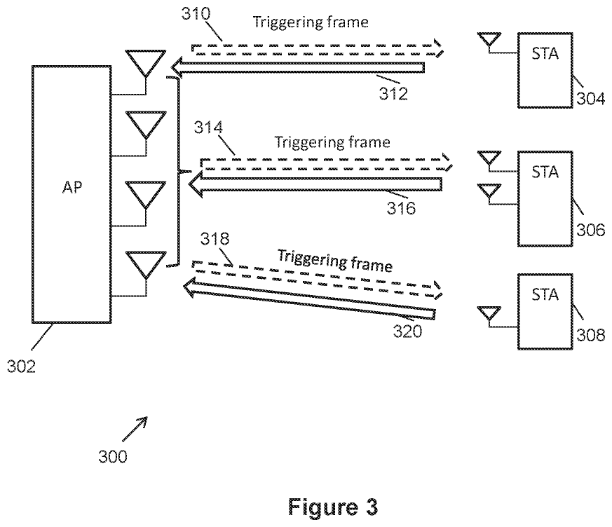

To enable uplink MU transmissions, trigger-based communication is provided to the MIMO wireless network. In this regard, FIG. 3 depicts a schematic diagram illustrating a trigger-based (TB) uplink MU communication 300 between an AP 302 and multiple STAs 304, 306, 308 in a MIMO wireless network.

Since there are multiple STAs 304, 306, 308 respectively participating in the trigger-based uplink MU communication, the AP 302 needs to coordinate simultaneous transmissions of multiple STAs 304, 306, 308.

To do so, as shown in FIG. 3, the AP 302 transmits triggering frames 310, 314, 318 simultaneously to STAs 304, 306, 308 respectively to indicate user-specific resource allocation information (e.g., the number of space-time streams, a starting STS number and the allocated RUs) that each STA can use. In response to the triggering frames, STAs 304, 306, 308 may then transmit their respective space-time streams simultaneously to the AP 302 according to the user-specific resource allocation information indicated in the triggering frames 310, 314, 318. For example, two space-time streams may be directed to the AP 302 from STA 306, another space-time stream may be directed to the AP 302 from STA 304, and yet another space-time stream may be directed to the AP 302 from STA 308. For the sake of simplicity, the two space-time streams directed to the AP 302 from STA 306 are illustrated as a grouped data transmission arrow 316, the space-time stream directed to the AP 302 from STA 304 is illustrated as a data transmission arrow 312, and the space-time stream directed to the AP 302 from STA 308 is illustrated as a data transmission arrow 320.

Due to packet/PPDU (physical layer protocol data unit) based transmission and distributed MAC (medium access control) scheme in 802.11 WLAN, time scheduling (e.g., TDMA (time division multiple access)-like periodic time slot assignment for data transmission) does not exist in 802.11 WLAN. Frequency and spatial resource scheduling is performed on a packet basis. In other words, resource allocation information is on a PPDU basis. The terms “packet”, “Physical layer (PHY) frame” and “physical layer protocol data unit (PPDU)” are often used interchangeably.

According to various embodiments, WLAN supports non-trigger-based communications as illustrated in FIG. 1 and trigger-based communications as illustrated in FIG. 2. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

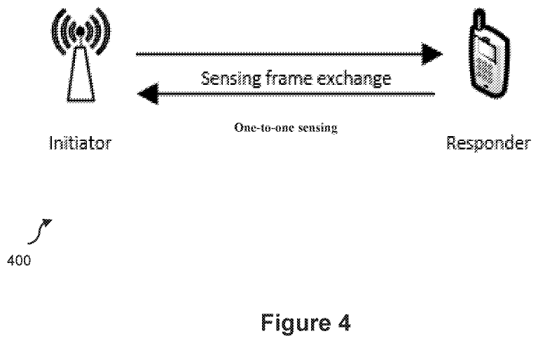

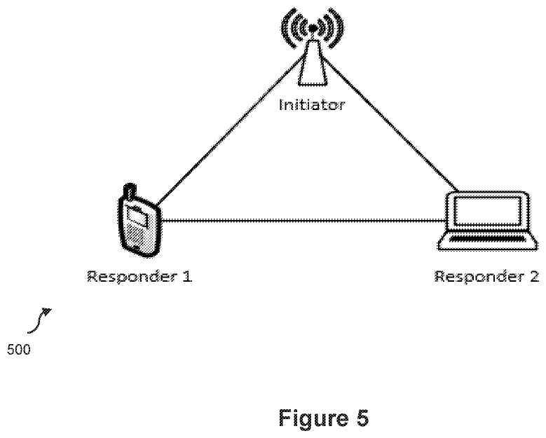

As mentioned above, WLAN sensing can be performed in two ways: (a) one-to-one sensing and (b) collaborative sensing. FIG. 4 depicts a diagram 400 illustrating one-to-one sensing performed by a sensing initiator and a sensing responder. The sensing is performed by exchanging sensing frames. FIG. 5 depicts a diagram 500 illustrating collaborative sensing performed by a sensing initiator and two sensing responders. In various embodiments of the present disclosure, one of the two sensing responders can become a sensing receiver and perform collaborative sensing for the sensing initiator. In some embodiments described in the present disclosure, such sensing responder which performs collaborative sensing can be a Non-AP STA (Non-Access Point Station) or an AP.

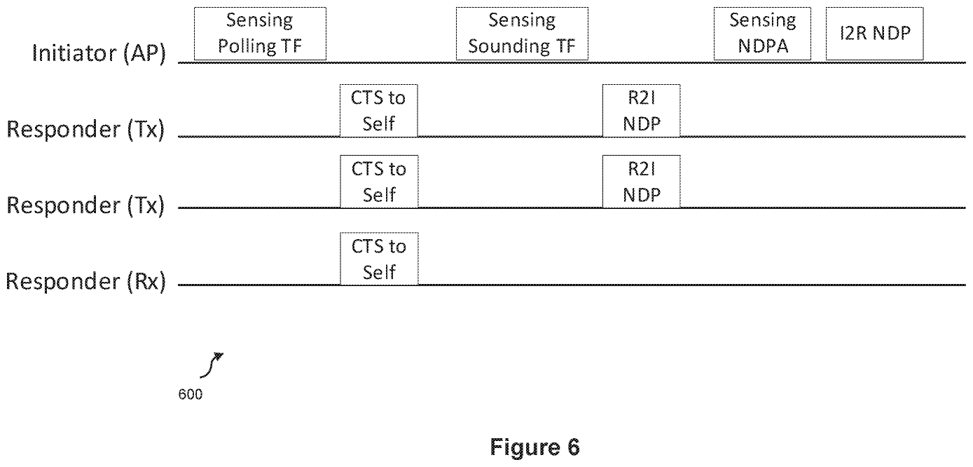

In addition, WLAN sensing measurement can be performed via Trigger-based (TB) sensing or non-TB sensing. TB sensing measurement is agreed as a method to perform WLAN sensing. FIG. 6 depicts a diagram 600 illustrating a procedural flow of a TB sensing measurement between a sensing initiator and three sensing responders. The sensing initiator in this case is an AP. Two of the three responders are sensing transmitter (Tx). The AP initiates a TB sensing measurement instance by first transmitting a Sensing Polling Trigger Frame (TF) to the three responders. Upon receipt of the Sensing Polling Trigger Frame, the three responders simultaneously transmit their respective Clear To Send (CTS) to Self frames to the AP. The AP then transmits a Sensing Sounding TF. The sensing transmitter (Tx), in response to the Sensing Sounding TF, transmits a Responder to Initiator (R2I) null data packet/PPDU (NDP) to the AP. The AP then transmits Sensing NDPA (NDP Announcement) frame followed by an Initiator to Responder (I2R) NDP and the Measurement Phase of the WLAN sensing may end.

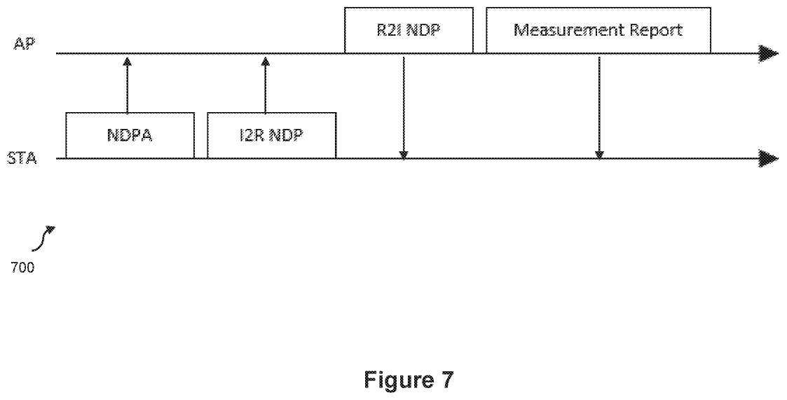

FIG. 7 depicts a diagram 700 illustrating a procedural flow of a non-TB sensing measurement between an AP as a sensing responder and a non-AP STA as a sensing initiator. Once the non-AP STA obtains a transmission opportunity (TXOP), it initiates a non-TB sensing measurement instance by first transmitting an NDPA frame to the AP followed by an I2R NDP, where the sensing initiator is a sensing transmitter and the sensing responder is a sensing receiver, after a short interframe spacing (SIFS). The AP, in response, transmit a R2I NDP to the non-AP STA, where the sensing initiator is a sensing receiver and the sensing responder is a sensing initiator, and there is another SIFS between the I2R NDP and the R2I NDP.

If the non-AP STA is only a sensing transmitter, then the NDPA frame should configure the R2I NDP to be transmitted with minimum possible length with one LTF (long training field) symbol. If the non-AP STA is only a sensing receiver, then the NDPA frame should configured the I2R NDP to be transmitted with minimum possible length with one LTF symbol.

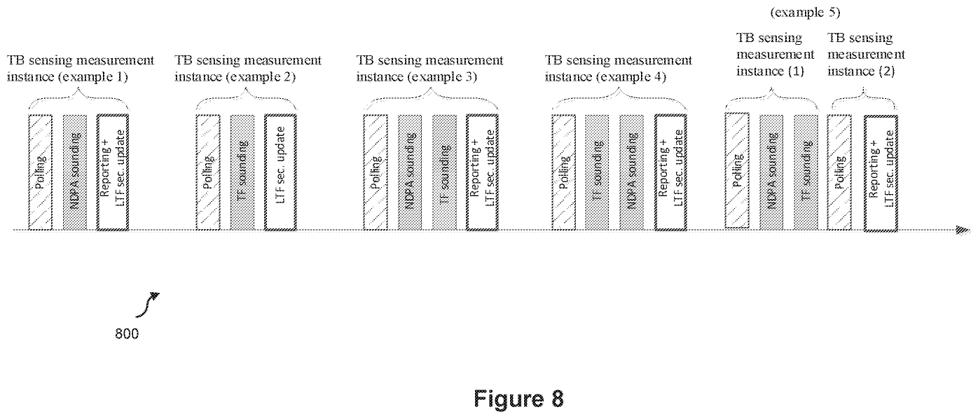

FIG. 8 depicts a diagram 800 illustrating five different TB sensing measurement examples. A TB sensing measurement instance includes a polling phase, an NDPA sounding phase, and a TF sounding phase. In TB sensing measurement instance example 1, a polling phase is followed by a NDPA sounding phase and a reporting and LTF security update phase. In TB sensing measurement instance example 2, a polling phase is followed by a TF sounding phase and a LTF security update phase. In TB sensing measurement instance example 3, a polling phase is followed by a NDPA sounding phase, a TF sounding phase and then a reporting and LTF security update phase. In TB sensing measurement instance example 4, a polling phase is followed by a TF sounding phase, a NDPA sounding phase and a reporting and LTF security update phase. In example 5, there are two TB sensing measurement instances. The first TB sensing measurement instance comprise a polling phase followed by a NDPA sounding phase and then a TF sounding phase. Then, the second TB sensing measurement instance is performed comprising another polling phase and a reporting and LTF security update phase.

During a sensing measurement step, the role(s) of a sensing responder shall be determined as one of: (i) a sensing receiver, (ii) a sensing transmitter, and (iii) a sensing transmitter and sensing receiver. The sensing procedure initiated by an AP can be enhanced to optionally allow “Sensing responder to Sensing responder” channel measurement. Prior art contribution is limited only to AP initiated sensing scenarios.

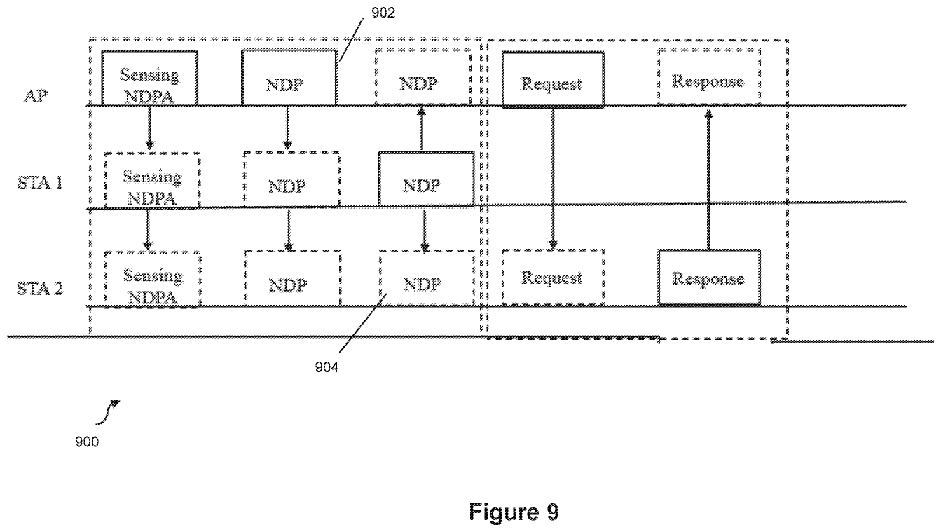

FIG. 9 depicts a flowchart 900 illustrating a procedural flow of a conventional sensing measurement between an AP and two STAs. In this example, the AP is a sensing initiator and the two STAs are sensing responders. The AP initiates a sensing measurement by transmitting a Sensing NDPA frame carrying information on sensing transmitter and sensing receiver(s) followed by a NDP 902 to STA1 and STA2. In this example, STA1 is the transmitter of sensing transmission, and AP and STA2 are the receivers. The transmitter (STA1) then transmits a NDP 904 to the receivers (AP and STA2), the NDP 904 comprising channel information between the receiver and the transmitter. The AP obtains measurement between itself and STA2 by the transmission from STA1 (e.g., NDP 904). No explicit measurement report from STA1 required. If required, then STA1 transmits it after NDP transmission. The AP (initiator) sends a request to STA2. STA2 feedbacks the measurement between STA1 and itself.

It is noted that STA2 has no indication that it will be receiving an NDP from STA1, as NDPA is received from the AP based on existing sounding sequence, NDP can be received from STA which sends an NDPA. Therefore, to implement collaborative sensing, there are changes required to the currently agreed details in IEEE 802.11bf Task Group (TGbf). According to the sensing measurement examples illustrated in FIG. 8, if conventional sensing sequence is implemented, the responder reports the sensing measurement result to the sensing initiator.

In conventional setting, the following are observed:
The responders have no knowledge of which responders are part of the collaborative sensing procedure;
For sensing between 2 non-AP STAs, current NDPA signalling does not include information about which STA is transmitting the NDP; and
There is no mechanism where the initiator can solicit a sensing measurement result from a responder which is not the intended channel measurement frame recipient.

Therefore, to implement collaborative sensing, the following need to be considered:
Add signalling so non-AP STA performing sensing can know about the STAs involved for collaborative sensing.
Add signalling for the measurement reporting phase, so the initiator can know which responders in the collaborative sensing group are to be solicited for sensing measurement result, the measurement report may be from multiple responders.

Based on the proposed signalling the initiator can know from the measurement report that the measurement report is from which responder in case of collaborative sensing,

Additionally, conventional apparatus and method only provide solution limited to only AP-initiated sounding sequence. Collaborative sensing for non-AP initiated cases were not described.

According to the present disclosure, a sensing initiator shall provide information in an announcement frame (e.g., NDPA, sounding Trigger frame) to a sensing responder capable of performing collaborative sensing (hereinafter referred to as collaborative sensing receiver) to decode sensing measurement PPDU (e.g., NDP) received from another sensing responder.

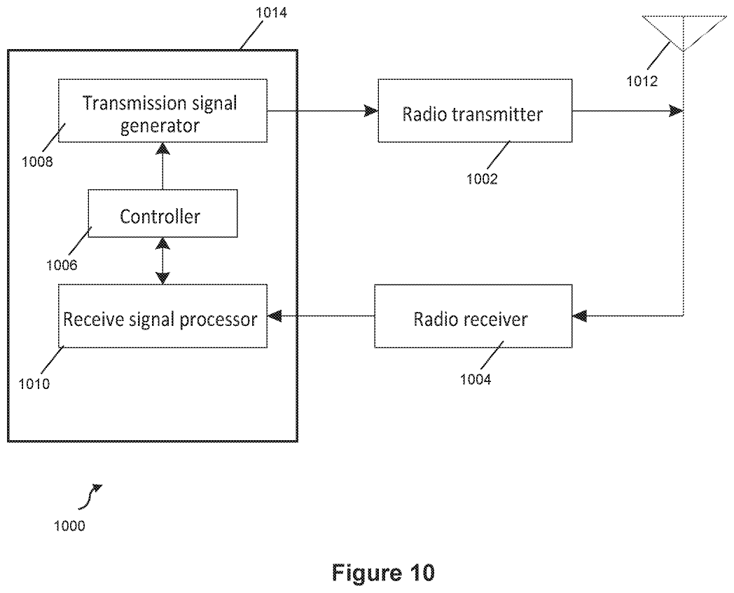

FIG. 10 depicts a schematic view of a communication apparatus 1000 according to the present disclosure. The communication apparatus 1000 may also be implemented as a sensing initiator, a sensing responder, or a collaborative sensing receiver.

As shown in FIG. 10, the communication apparatus 1000 may include circuitry 1014, at least one radio transmitter 1002, at least one radio receiver 1004, and at least one antenna 1012 (for the sake of simplicity, only one antenna is depicted in FIG. 10 for illustration purposes). The circuitry 1014 may include at least one controller 1006 for use in software and hardware aided execution of tasks that the at least one controller 1006 is designed to perform, including control of communications with one or more other communication apparatuses in a wireless network. The circuitry 1014 may further include at least one transmission signal generator 1008 and at least one receive signal processor 1010. The at least one controller 1006 may control the at least one transmission signal generator 1008 for generating MAC frames and PPDUs to be sent through the at least one radio transmitter 1002 to one or more other communication apparatuses, wherein the MAC frames, for example, may be Polling Trigger frame, Sounding Trigger frame, NFRP Trigger frame; and the PPDU, for example, may be PPDUs used for non-trigger-based communications, PPDUs used for trigger-based sounding procedure, PPDUs used for trigger-based downlink transmissions if the communication apparatus 1000 is an AP, or PPDUs used for trigger-based uplink transmissions if the communication apparatus 1000 is a STA. The at least one controller 1006 may control the at least one receive signal processor 1010 for processing MAC frames and PPDUs received through the at least one radio receiver 1004 from the one or more other communication apparatuses under the control of the at least one controller 1006, wherein the MAC frames, for example, may be Polling Trigger frame, Sounding Trigger frame, NFRP Trigger frame; and the PPDU, for example, may be PPDUs used for non-trigger-based communications, PPDUs used for trigger-based sounding procedure, PPDUs used for trigger-based uplink transmissions if the communication apparatus 1000 is an AP, or PPDUs used for trigger-based downlink transmissions if the communication apparatus 1000 is a STA. The at least one transmission signal generator 1008 and the at least one receive signal processor 1010 may be stand-alone modules of the communication apparatus 1000 that communicate with the at least one controller 1006 for the above-mentioned functions, as shown in FIG. 1010. Alternatively, the at least one transmission signal generator 1008 and the at least one receive signal processor 1010 may be included in the at least one controller 1006. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1002, at least one radio receiver 1004, and at least one antenna 1012 may be controlled by the at least one controller 1006.

The communication apparatus 1000, when in operation, provides functions required for collaborative WLAN sensing. For example, the communication apparatus 1000 may be a collaborative sensing receiver, and the at least one radio receiver 1004 may, in operation, receive a sounding signal, from a sensing transmitter, wherein the sensing transmitter is configured to perform a first channel measurement with a sensing initiator. The circuitry 1014 (for example the at least one receive signal processor 1010 of the circuitry 1014) may, in operation, be configured to perform a second channel measurement with the sensing transmitter upon receiving the sounding signal.

In an embodiment, the at least one radio receiver 1004, may receive a request signal comprising a signal field for the receiving communication apparatus prior to receiving the sounding signal, the signal field comprising first information to perform the second channel measurement.

The at least one radio receiver 1004, may receive a setup signal to establish a tunnelled direct link with the initiating communication apparatus prior to receiving the request signal, and then receive a second sounding signal from the initiating communication apparatus through the tunnelled direct link subsequent to receiving the request signal. The circuitry 1014 (for example the at least one receive signal processor 1010 of the circuitry 1014) may be configured to perform a third channel measurement with the initiating communication upon receiving the second sounding signal. Alternatively, the at least one radio receiver 1004, may receive a setup signal from the initiating communication apparatus, wherein the setup signal comprises second information to perform the second channel measurement.

The communication apparatus 1000 may be a sensing transmitter, and the circuitry 1014 (for example the at least one receive signal processor 1010 of the circuitry 1014) may, in operation, be configured to perform a first channel measurement with a sensing initiator and the circuitry 1014 (for example the at least one transmission signal generator 1008 of the circuitry 1014) may generate a sounding signal. The at least radio transmitter 1002 may then transmit the sounding signal to a collaborative sensing receiver, wherein the collaborative sensing receiver receives the sounding signal and performs a second channel measurement with the sensing transmitter.

The communication apparatus 1000 may be a sensing initiator, and the circuitry 1014 (for example the at least one transmission signal generator 1008 of the circuitry 1014) may generate a request signal. The at least one radio transmitter 1002 may then transmit the request signal to a sensing transmitter, wherein the sensing transmitter is configured to perform a first channel measurement with the sensing initiator upon receiving the request signal and a collaborative sensing receiver is configured to perform a second channel measurement with the sensing transmitter upon receiving a sounding signal from the sensing transmitter.

The at least one radio transmitter 1002 may further transmit the request signal to the receiving communication apparatus, the request signal comprising a signal field for the receiving communication apparatus, the signal field comprising first information to perform the second channel measurement.

The at least one radio transmitter 1002 may transmit a setup signal to establish a tunnelled direct link with the receiving communication apparatus prior to transmitting the request signal, and transmit a second sounding signal to the receiving communication apparatus through the tunnelled direct link subsequent to transmitting the request signal, wherein receiving communication apparatus is configured to perform a third channel measurement with the initiating communication upon receiving the second sounding signal. Alternatively, the at least one radio receiver 1004 may receive a setup signal from the receiving communication apparatus prior to the receiving the request signal, wherein the setup signal comprises second information to perform the second channel measurement.

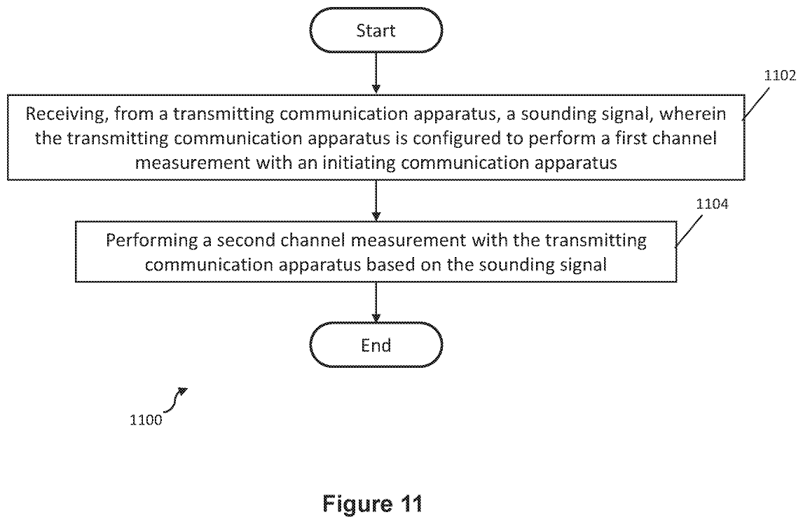

FIG. 11 shows a flowchart 1100 illustrating a communication method implemented by a receiving communication apparatus according to various embodiments of the present disclosure. In step 1102, the receiving communication apparatus receives, from a transmitting communication apparatus, a sounding signal, wherein the transmitting communication apparatus is configured to perform a first channel measurement with an initiating communication apparatus. In step 1104, a step of performing a second channel measurement with the transmitting communication apparatus is carried out based on the sounding signal.

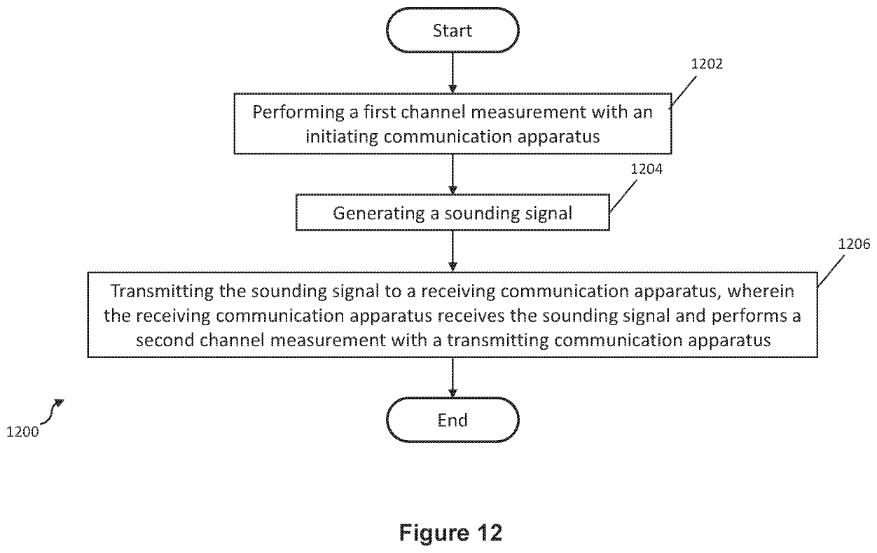

FIG. 12 shows a flowchart 1200 illustrating a communication method implemented by a transmitting communication apparatus according to various embodiments of the present disclosure. In step 1202, a step of performing a first channel measurement with an initiating communication apparatus is carried out. In step 1204, a step of generating a sounding signal is carried out. In step 1206, a step of transmitting the sounding signal to a receiving communication apparatus is carried out, wherein the receiving communication apparatus receives the sounding signal and performs a second channel measurement with a transmitting communication apparatus.

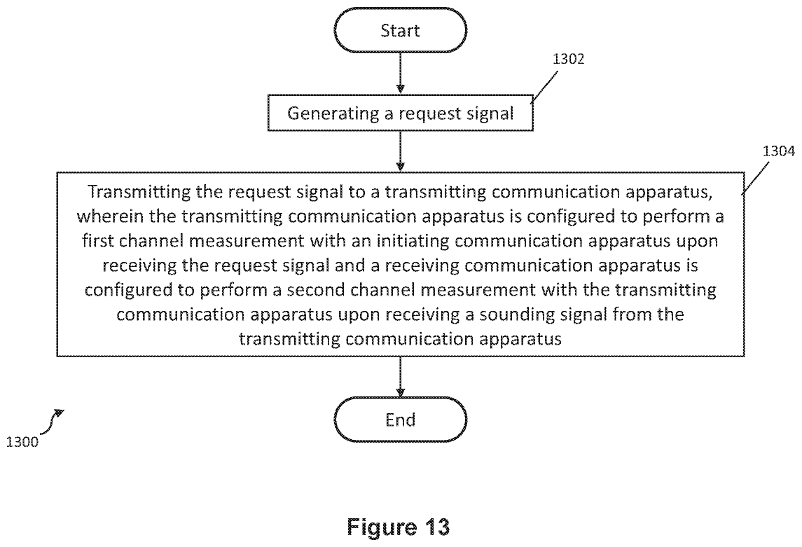

FIG. 13 shows a flowchart 1300 illustrating a communication method implemented by an initiating communication apparatus according to various embodiments of the present disclosure. In step 1302, a step of generating a request signal is carried out. In step 1304, a step of transmitting the request signal to a transmitting communication apparatus is carried out, wherein the transmitting communication apparatus is configured to perform a first channel measurement with an initiating communication apparatus upon receiving the request signal and a receiving communication apparatus is configured to perform a second channel measurement with the transmitting communication apparatus upon receiving a sounding signal from the transmitting communication apparatus.

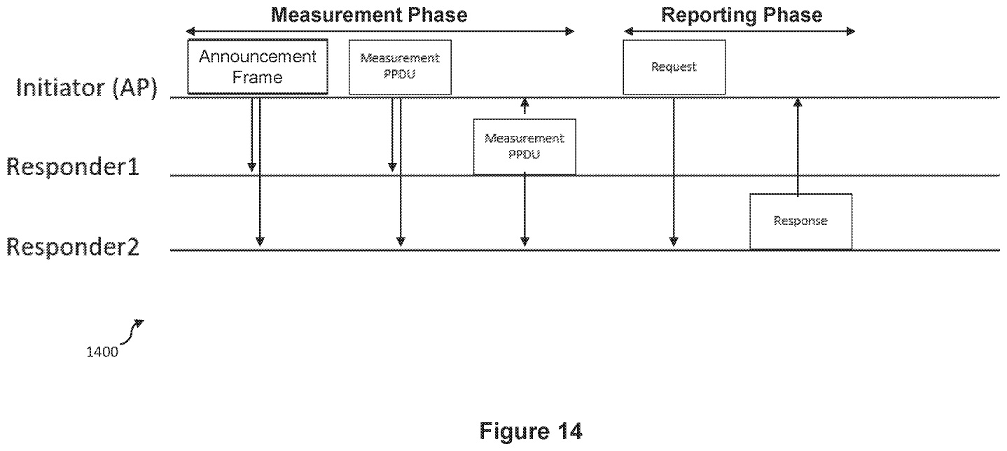

FIG. 14 depicts a diagram 1400 illustrating a procedural flow of a collaborative sensing measurement between a sensing initiator (AP) and two sensing responders according to various embodiments of the present disclosure. The collaborative sensing measurement comprises a measurement phase and a reporting phase. During measurement phase, the sensing initiator (AP) initiates the sensing measurement instance by first transmitting an announcement frame followed by a measurement PPDU. The announcement frame provides information about collaborative sensing. The sensing responder 1 capable of performing collaborative sensing then transmits a measurement PPDU to the initiator and other sensing responder (i.e., sensing responder 2).

During the reporting phase, the sensing initiator (AP) transmits a request for a measurement result, and the responder 2, in response to the request, transmits the measurement result to the sensing initiator.

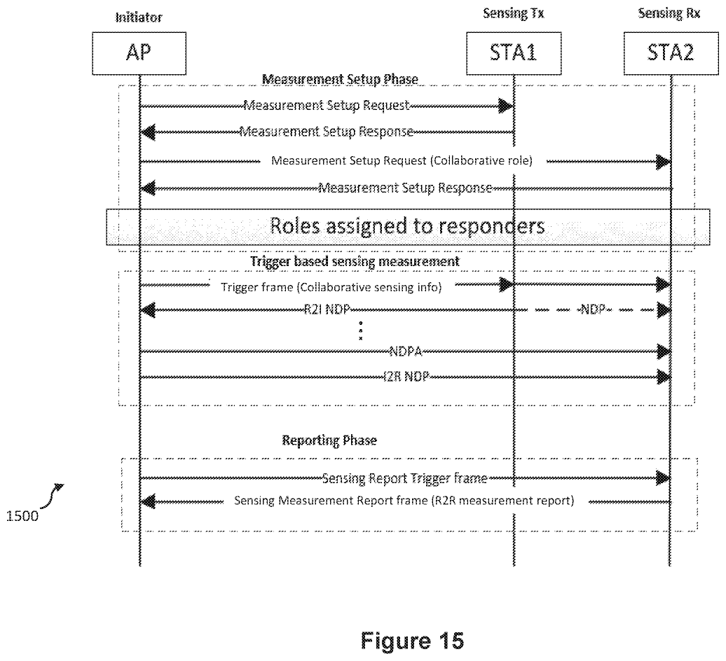

FIG. 15 depicts a flowchart 1500 illustrating an example collaborative sensing procedure with TB sensing measurement between a sensing initiator (AP) and two sensing responders (STA1, STA2) according to various embodiments of the present disclosure. The procedure comprises a measurement setup phase, a trigger-based sensing measurement phase and a reporting phase. In this case, sensing responder STA1 is a sensing transmitter and sensing responder STA2 is a sensing receiver (capable of collaborative sensing). During measurement setup phase, the initiator assigns the sensing roles to the responders capable of collaborative sensing (i.e., STA2). This is achieved by first transmitting a Measurement Setup Request frame to sensing transmitter STA1, and the STA1, in response, transmits a Measurement Setup Response frame to the AP. The AP then transmits another Measurement Setup Request frame with an indication to assign the sensing role to collaborative sensing receiver STA2, and the STA2, in response, transmits a Measurement Setup Response frame to the AP. With such steps, the roles are now assigned to the responder which can perform collaborative sensing (i.e., STA2).

During trigger-based sensing measurement phase, the sensing initiator (AP) first initiates the sensing measurement by transmitting a Trigger frame carrying information for collaborative sensing receiver (STA2) to perform collaborative sensing to both STA1 and STA2. The sensing responder (transmitter), i.e., STA1, then transmits a R2I NDP back to the AP. With the role of a collaborative sensing receiver, sensing responder STA2 is also able to receive the NDP transmitted by the sensing transmitter STA1 (Responder to Responder (R2R) measurement). Subsequently, when the sensing responder is a sensing receiver, the sensing initiator transmits a NDPA frame followed by a I2R NDP to the collaborative sensing receiver, and the measurement sensing phase may end.

During the reporting phase for TB measurement phase, the sensing initiator transmits a Sensing Report Trigger frame to the collaborative sensing receiver STA2, and the STA2, in response, transmits a Sensing Measurement Report frame comprising a Responder to Responder (R2R) measurement report to the sensing initiator.

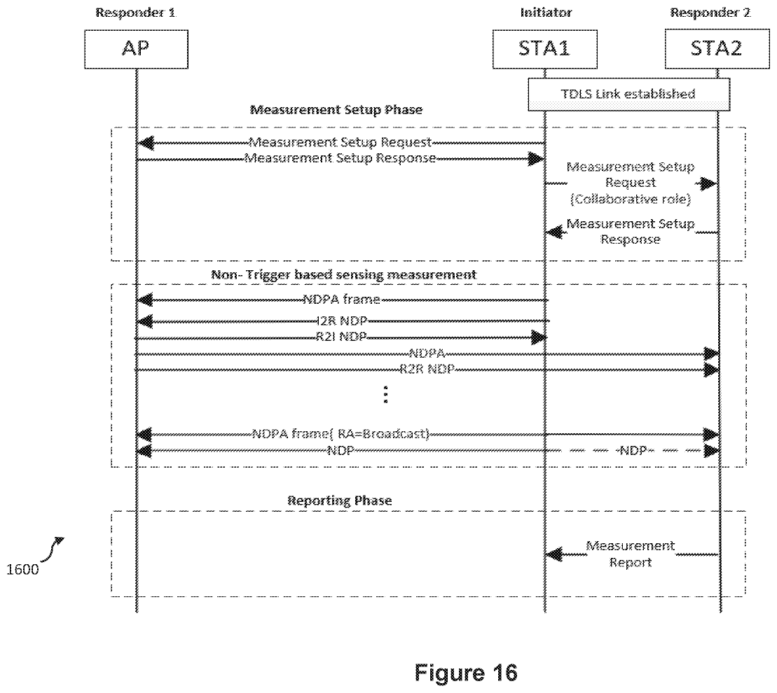

FIG. 16 depicts a flowchart 1600 illustrating an example collaborative sensing procedure with non-TB sensing measurement between a sensing initiator (STA1) and two sensing responders (AP, STA2) according to various embodiments of the present disclosure. The procedure comprises a measurement setup phase, a non-trigger-based sensing measurement phase and a reporting phase. In this case, the STA1 is a sensing initiator, the AP is a sensing responder, the STA2 is a sensing responder (capable of collaborative sensing), and a Tunnelled Direct Link Setup (TDLS) is established between the STA1 and STA2.

In this case, the sensing initiator (STA1) wishes to perform sensing measurement with the AP. During measurement setup phase, the initiator (STA1) transmits a Measurement Setup Request frame to the AP, and the AP, in response, transmits a Measurement Setup Response frame back to the STA1. The STA1 then transmits another Measurement Setup Response frame to the STA2 with an indication to assign the collaborative sensing role to the STA2 over the Tunnelled Direct Link Setup (TDLS). The STA2, in response, transmits a Measurement Setup Response frame to the STA1. With such steps, the roles are now assigned to the STA2 to perform collaborative sensing.

During non-trigger based measurement phase, the sensing initiator (STA1) initiates the sensing measurement by transmitting a NDPA frame followed by an I2R NDP to the AP, and the AP, in response, transmits a R2I NDP back to the STA1. The AP also transmits a NDPA frame followed by a R2R NDP (responder-to-responder NDP) to the STA2. Subsequently, the sensing initiator STA1 transmits a NDPA frame with Recipient Address (RA) field set to “Broadcast” to all sensing responders (AP and STA2) followed by a NDP to the AP. With the role of a collaborative sensing receiver, the sensing responder STA2 is able to receive the NDP transmitted by the STA1.

During reporting phase, the collaborative sensing receiver STA2 can transmit a Sensing Measurement Report to the sensing initiator STA1 over the Tunnelled Direct Link.

In the following paragraphs, a first embodiment of the present disclosure where a TB Sounding procedure is used for TB collaborative sensing procedure is described.

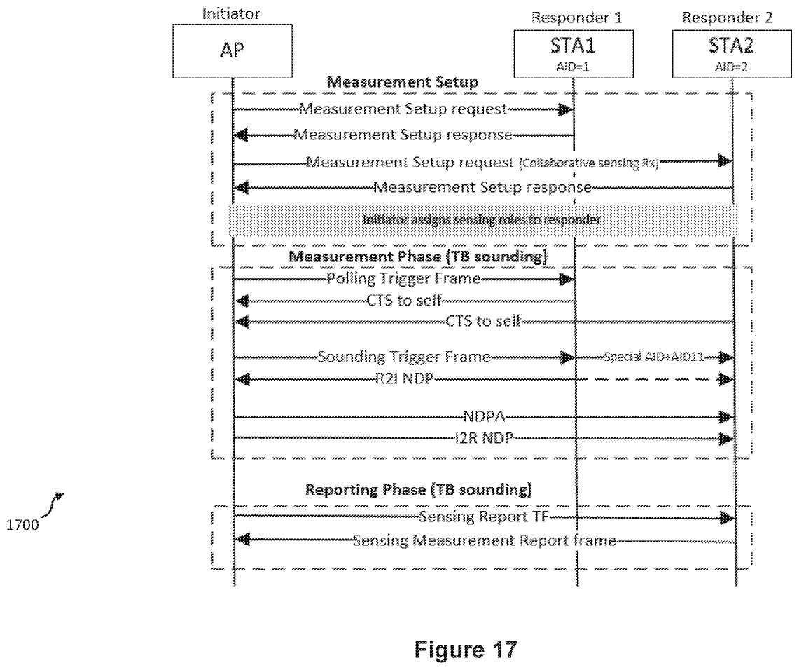

FIG. 17 depicts a flowchart 1700 illustrating an example TB collaborative sensing procedure between a sensing initiator (AP) and two sensing responders (STA1, STA2) according to an embodiment of the present disclosure. The procedure comprises a measurement setup phase, a measurement phase via a TB sounding procedure and a reporting phase via a TB sounding procedure. In this case, sensing responder STA1 (e.g., AID=1) is a sensing transmitter and sensing responder STA2 (e.g., AID=2) is a sensing receiver (capable of collaborative sensing). During measurement setup phase, the initiator AP first transmits a Measurement Setup Request frame to the sensing transmitter STA1, and the STA1, in response, transmits a Measurement Setup Response frame to the AP. The initiator AP then transmits another Measurement Setup Request frame with an indication to assign the collaborative sensing role to the STA2, and the STA2, in response, transmits a Measurement Setup Response frame to the AP. With such steps, the role of collaborative sensing is assigned to the STA2. In an embodiment, the Measurement Setup Request frame and Measurement Setup Response frame exchanged between STAs to perform the sensing measurement setup are protected Sensing Session Setup request and response frames.

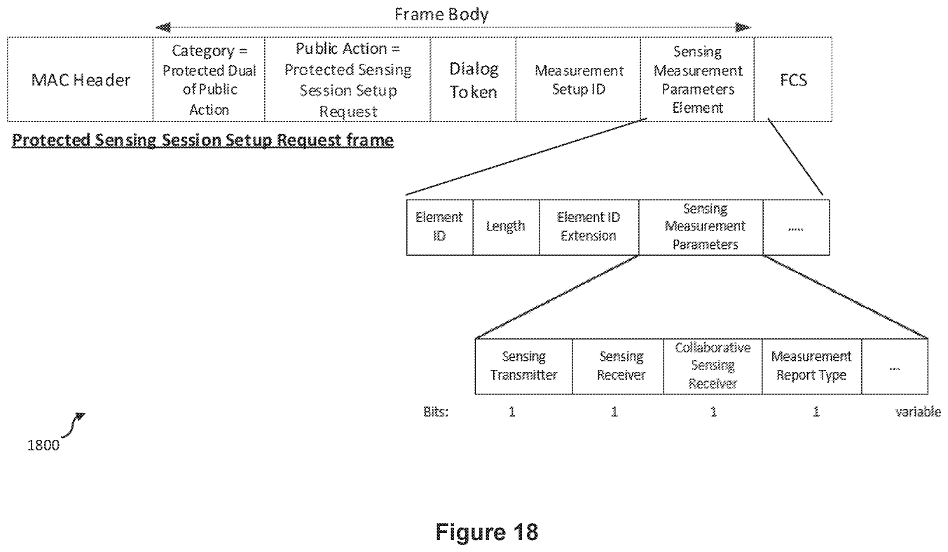

FIG. 18 depicts an example of protected Sensing Session Setup Request frame 1800 according to the first embodiment of the present disclosure. The protected Sensing Session Setup Request frame 1800 comprises a MAC Header (Frame Control field, Duration field, RA field and TA field), a Category field, a Public Action field, a Dialog Token field, a Measurement ID field, a Sensing Measurement Parameters Element field, and a frame checking sequence (FCS) field. The Category field is set to “Protected Dual of Public Action” and the Public Action field is set to “Protected Sensing Session Setup Request”. The Sensing Measurement Parameter Element field comprises an Element ID subfield, a Length subfield, an Element ID Extension subfield, a Sensing Measurement Parameters subfield. The Measurement Setup ID field carries a measurement ID being negotiated between the two STAs.

The Sensing Measurement Parameters subfield carries the parameters related to the sensing measurement setup, for illustration, parameters related to sensing types and types of measurement reports (e.g., channel state information (CSI), partial CSI, etc.). The Sensing Measurement Parameters subfield may comprise a Sensing Transmitter subfield, a Sensing Receiver subfield, a Collaborative Sensing Receiver subfield and a Measurement Report Type subfield. The Collaborative Sensing Receiver subfield is set to 1 to indicate an assignment of a collaborative sensing receiver role to a collaborative sensing capable STA.

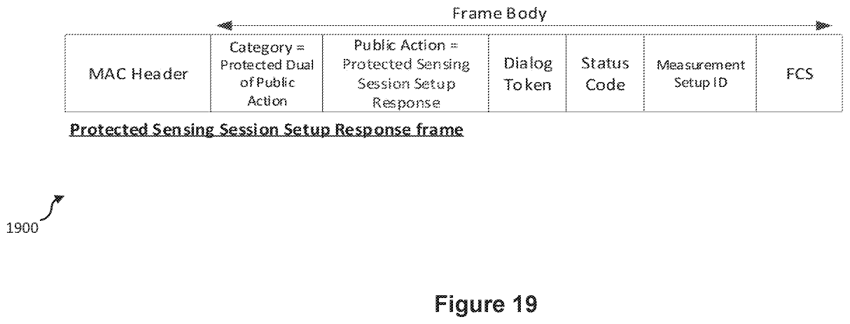

FIG. 19 depicts another example of protected Sensing Session Setup Response frame 1900 according to the first embodiment of the present disclosure. The protected Sensing Session Setup Response frame 1900 comprises a MAC Header (Frame Control field, Duration field, RA field and TA field), a Category field, a Public Action field, a Dialog Token field, a Status Code field, a Measurement Setup ID field, and an FCS field. The Category field is set to “Protected Dual of Public Action” and the Public Action field is set to “Protected Sensing Session Setup Response”. The Measurement Setup ID field carries a measurement ID being negotiated between the two STAs. The Status Code field indicates if the sensing measurement setup is successful or not.

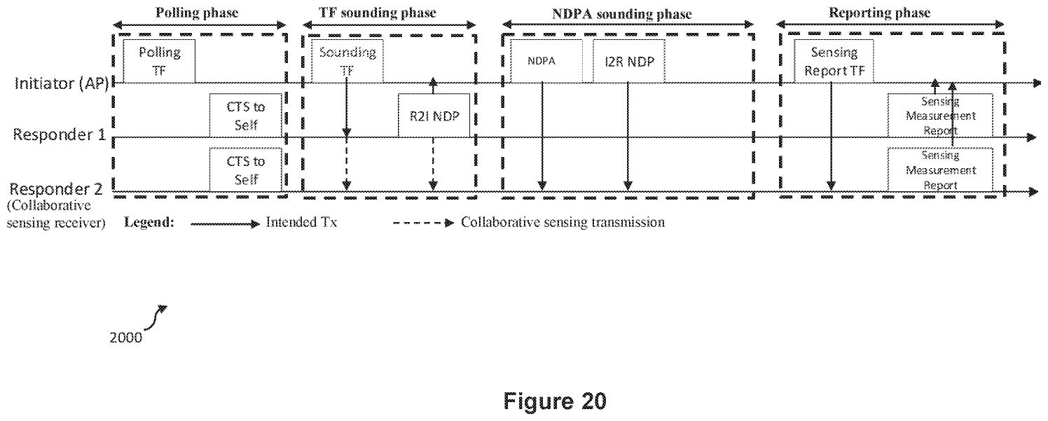

Returning to FIG. 17, during trigger-based sensing measurement phase, a TB sounding procedure (sensing measurement instance) is carried out. FIG. 20 depicts a flowchart 2100 illustrating a procedural flow of a sensing measurement instance using a TB sounding procedure between the sensing initiator (AP) and the two sensing responders (STA1, STA2) in FIG. 17 according to an embodiment of the present disclosure. The Sensing Measurement instance comprises a Polling phase, a TF sounding phase, a NDPA sounding phase and a Reporting phase.

During the Polling phase of the sensing measurement instance, the sensing initiator (AP) first initiates the sensing measurement by transmitting a Polling Trigger frame (TF)) to one or more STAs that are assigned to be polled in the TB sensing measurement instance and expected to participate during the available period (in this case, both STA1 and STA2). The polling TF is used to check availability of the responder STAs and to allocate resources for transmission. The STA1 and STA2 each, in response to the Polling TF, transmits a CTS to self frame to the AP to indicate that it is available for TB sensing.

Next, during the TF sounding phase, the AP then transmits a Sounding Trigger frame to solicit NDP transmissions (R2I NDP) from one or more STAs (in this case, STA1 (sensing transmitter)) to perform channel measurement, the Sounding TF carrying User Info field for STAs participating in sensing and User Info for collaborative sensing receiver comprising a Special AID (Association Identifier), in this case Special AID11, and parameters for responder to correctly decode subsequent NDP(s). The Special AID provides the collaborative sensing receiver information about the subsequent NDP it may receive from another responder. A collaborative sensing receiver identify the User Info field carrying the Special AID and Collaborative Sensing AID subfield addressed to its own AID and obtain the collaborative sensing information and NDP transmission parameters from the User Info field.

Both STA1 and STA2 receive the Sounding TF. The STA1, in response, transmits a R2I NDP comprising a feedback response to the AP. With the collaborative sensing receiver role assigned and NDP information which may be received from another responder, the STA2 is able to receive and decode the NDP transmitted by the STA1 too.

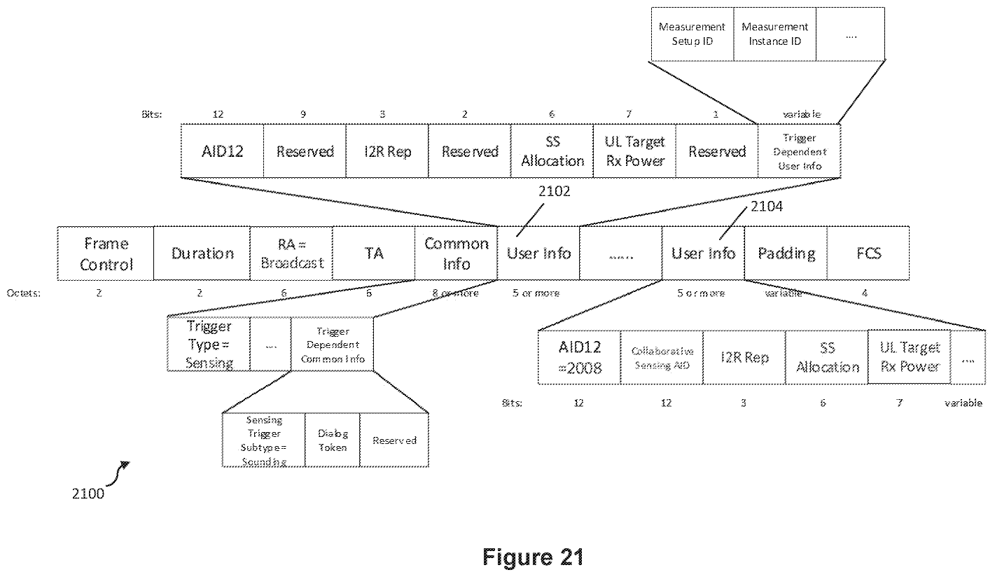

FIG. 21 depicts an example format of a sounding TF 2100 according to the first embodiment of the present disclosure. The sounding TF 2100 comprises a Frame Control field, a Duration field, a Recipient field set to “broadcast”, a Transmitter field, a Common Info field, one or more User Info field, a Padding field and an FCS field. The Common Info field comprises a Trigger Type subfield set to “Sensing” and a Trigger Dependent Common Info subfield. The Trigger Dependent Common Info subfield comprises a Sensing Trigger Subtype set to “Sounding” and a Dialog Token field. For collaborative sensing purpose, the sounding TF 2100 comprises two different User Info fields 2102, 2104, one User Info field 2102 for Sensing transmitter (e.g., STA1 of FIGS. 17 and 20) and another User Info field 2104 for collaborative sensing receiver (e.g., STA2 of FIGS. 17 and 20). The User Info field 2102 for sensing transmitter comprises a AID12 subfield, a I2R Repetition (Rep) subfield, a Spatial Stream (SS) Allocation subfield, an UL (uplink) Target Receive (Rx) Power subfield and a Trigger Dependent User Info subfield. The Trigger Dependent User Info subfield comprises a Measurement Setup ID subfield and a Measurement Instance ID subfield. The other User Info field 2104 for collaborative sensing receiver comprises a AID12 subfield set to 2008 (special AID for collaborative sensing receiver), a Collaborative Sensing Associated Identifier (AID) subfield, a I2R Rep subfield, a SS Allocation subfield and a UL Target Rx Power subfield. The I2R Rep subfield, SS Allocation subfield and the UL Target Rx Power subfield correspond to R2R NDP parameters. The Collaborative Sensing AID is the associated ID of the collaborative sensing receiver. It is noted that the number 2008 used as the Special AID for collaborative sensing receiver is just an example. Other valid number can be used in lieu of the number 2008 from the IEEE 802.11 standard for the same purpose.

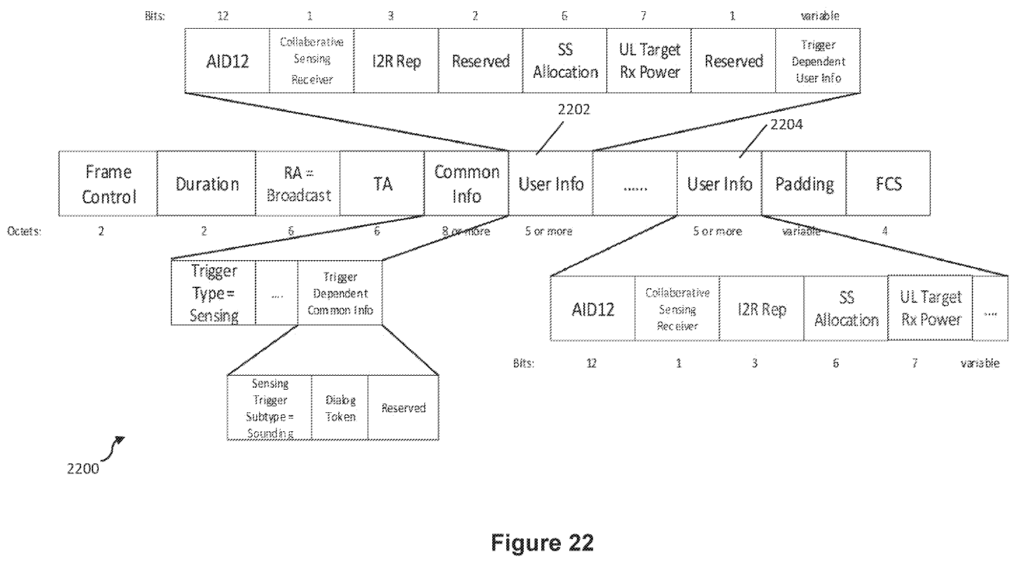

FIG. 22 depicts another example format of a sounding TF 2200 according to the first embodiment of the present disclosure. The sounding TF 2200 comprises a Frame Control field, a Duration field, a Recipient field set to “broadcast”, a Transmitter field, a Common Info field, one or more User Info field, a Padding field and an FCS field. The Common Info field comprises a Trigger Type subfield set to “Sensing” and a Trigger Dependent Common Info subfield. The Trigger Dependent Common Info subfield comprises a Sensing Trigger Subtype set to “Sounding” and a Dialog Token field. For collaborative sensing purpose, the sounding TF 2200 comprises two different User Info fields 2202, 2204, one User Info field 2202 for Sensing transmitter (e.g., STA1 of FIGS. 17 and 20) and another User Info field 2204 for collaborative sensing receiver (e.g., STA2 of FIGS. 17 and 20). The User Info field 2202 for sensing transmitter comprises a AID12 subfield, a Collaborative Sensing Receiver subfield (instead of AID in FIG. 21), I2R Rep subfield, a SS Allocation subfield, an UL Target Receive Power subfield and a Trigger Dependent User Info subfield. The other User Info field 2204 for collaborative sensing receiver comprises a AID12 subfield, a Collaborative Sensing Receiver subfield, a I2R Rep subfield, a SS Allocation subfield and a UL Target Rx Power subfield. The I2R Rep subfield, SS Allocation subfield and the UL Target Rx Power subfield correspond to R2R NDP parameters.

The Collaborative Sensing Receiver subfields in both the User Info fields 2202, 2204 can be set to 1 for collaborative sensing indication, indicating that this User Info is for a collaborative sensing capable receiver.

Returning to FIGS. 17 and 20, during the NDPA sounding phase, the AP transmits a NDPA frame to the sensing responder which is a sensing receiver (in this case, STA2) followed by a I2R NDP. The NDPA frame carries User (STA) Info field for STAs participating in sensing and User Info for collaborative sensing receiver comprising a Special AID for responder to correctly decode subsequent NDP(s). The Special AID provides the collaborative sensing receiver information about the subsequent NDP it may receive from another responder. A collaborative sensing receiver identify the User (STA) Info field carrying the Special AID and Collaborative Sensing AID subfield addressed to its own AID and obtain the collaborative sensing information and NDP transmission parameters from the User (STA) Info field.

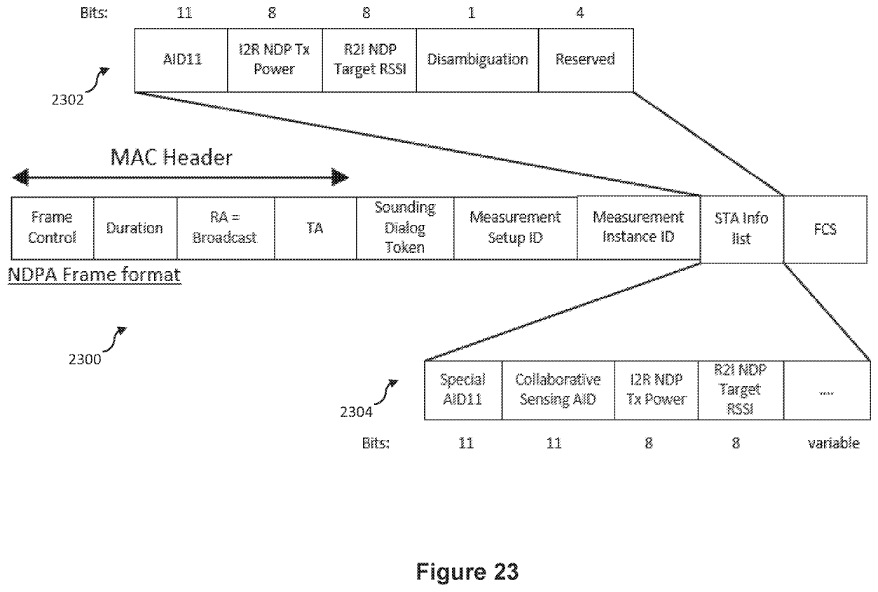

FIG. 23 depicts an example format of an NDPA frame 2300 according to the first embodiment of the present disclosure. The NDPA frame 2300 comprises a Frame Control field, a Duration field, a RA field, a TA field, a Sounding Dialog Token field, a Measurement Setup ID field, a Measurement Instance ID field, a STA Info List field, and an FCS field. The Frame Control field, the Duration field, the RA field and the TA field may be grouped as MAC header. The RA field is set to “Broadcast”. Similar to the sounding TF 2100/2200, for collaborative sensing purpose the STA Info List field comprises two different STA Info fields, one STA Info field 2302 for sensing transmitter (e.g., STA1 of FIGS. 17 and 20) and another STA Info field 2304 for collaborative sensing receiver (e.g., STA2 of FIGS. 17 and 20). The STA Info field 2302 comprises a AID11 subfield, a I2R NDP Tx Power subfield, a R2I NDP Target Received Signal Strength Indicator (RSSI) subfield and a Disambiguation subfield. The other STA Info field 2304 comprises a Special AID11 subfield (for collaborative sensing receiver), a Collaborative Sensing AID subfield, a I2R NDP Tx Power subfield and a R2I NDP Target RSSI subfield. The I2R NDP Tx Power subfield and the R2I NDP Target RSSI subfield indicate the NDP Tx parameters it may receive from another responder. The Collaborative Sensing AID is the association ID of the collaborative sensing receiver. The Special AID11 for collaborative sensing receive has a value of 4096. It is appreciated that other valid number can be used in lieu of the number 4096 from the IEEE 802.11 standard for the same purpose. Alternatively, the Special AID subfield may contain 1 bit as a collaborative sensing indication, indicating that this User Info is for a collaborative sensing capable receiver.

Returning to FIGS. 17 and 20, lastly, during the reporting phase, the AP solicits R2R sensing measurement report by transmitting a Sensing Report Trigger Frame (TF) to the STA2 and the STA2, in response, transmits a Sensing Measurement Report frame comprising the sensing measurement result (e.g., R2R measurement report) to the initiator (AP). In the example illustrated in FIG. 20, the Sensing Report TF solicits sensing measurement result from STA2. The sensing measurement report from STA2 comprise of R2I NDP from TF sounding phase and I2R NDP from NDPA sounding phase. The sensing measurement report can be identified and differentiated from a sensing measurement report transmitted by another STA (e.g., STA1) using the sensing measurement instance ID and the initiator may understand if the report is for collaborative sensing scenario if a bit is set in the Collaborative Measurement Report field of the Sensing Measurement Control subfield of the Sensing Measurement report.

The reporting phase can be a collaborative sensing sequence in a non-TB sensing measurement instance. The sensing initiator transmits a Sensing Report Trigger frame to the collaborative sensing receiver STA2, and the STA2, in response, transmits a Sensing Measurement Report frame comprising a Responder to Responder (R2R) measurement report to the sensing initiator.

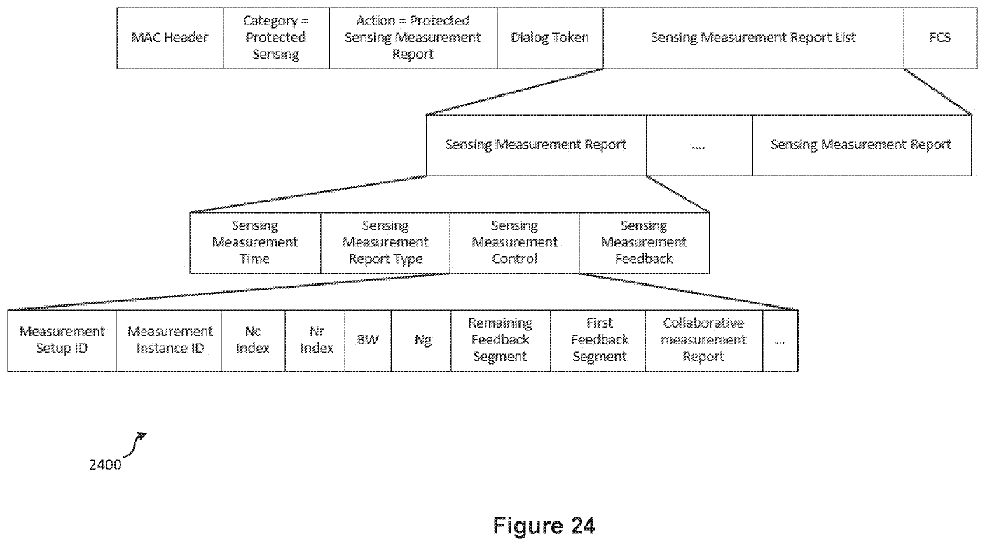

FIG. 24 depicts an example format of a Sensing Measurement Report frame 2400 according to the first embodiment of the present disclosure. The Sensing Measurement Report frame 2400 comprises a MAC header (Frame Control field, Duration field, RA field and TA field), a Category field, an Action field, a Dialog Token field, a Sensing Measurement Report List field and an FCS field. The Sensing Measurement Report List field carries one or more Sensing Measurement Report frames, each of which comprising a Sensing Measurement Time subfield, a Sensing Measurement Report Type subfield, a Sensing Measurement Control subfield and a Sensing Measurement Feedback subfield. The Sensing Measurement Control subfield comprises a Measurement Setup ID subfield, a Measurement Instance ID field, a Nc index field, a Nr index field, a BW field, a Ng field, a Remaining Feedback Segment field, a First Feedback Segment field and a Collaborative Measurement Report field. The Sensing Measurement Time field indicates the time at which the sensing measurement was performed, i.e., the time at which sensing NDP was received, for example 4 lowest significant bits of device timing synchronization function (TSF). The Sensing Measurement Time subfield for each sensing measurement report will help AP to understand which is the first report and which are subsequent report (similar to timestamp). The Sensing Measurement Feedback subfield carries result for collaborative sensing if the Collaborative Measurement Report subfield is set to 1 and the initiator can identify the collaborative measurement report based on the value of this subfield.

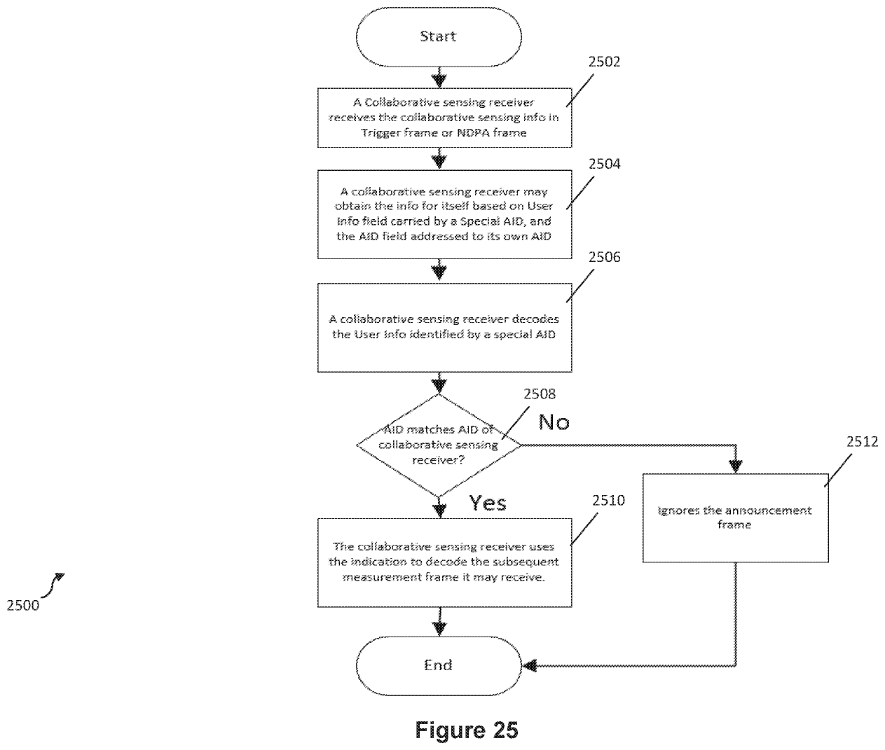

FIG. 25 depicts a flowchart 2500 illustrating a process implemented by a collaborative sensing receiver according to the first embodiment of the present disclosure. In step 2502, a sensing responder capable of performing collaborative sensing (herein referred to as “collaborative sensing receiver”) receives a collaborative sensing information in a Trigger frame or NDPA frame. In step 2504, the collaborative sensing receiver performs a step of obtaining the information for itself based on a User Info field carried by a Special AID, and the AID field addressed to its own AID. In step 2506, the collaborative sensing receiver performs a step of decoding the User Info field identified by the Special AID. In step 2508, it is determined if the AID (e.g., the AID in the Collaborative Sensing AID subfield) matches the AID of the collaborative sensing receiver. If it is determined that the AID matches its AID, step 2510 is carried out; otherwise step 2512 is carried out. In step 2510, a step of using the indication to decode the subsequent measurement frame it may receive is carried out. In step 2512, the announcement frame received in the step 2502 is ignored, and the process may end.

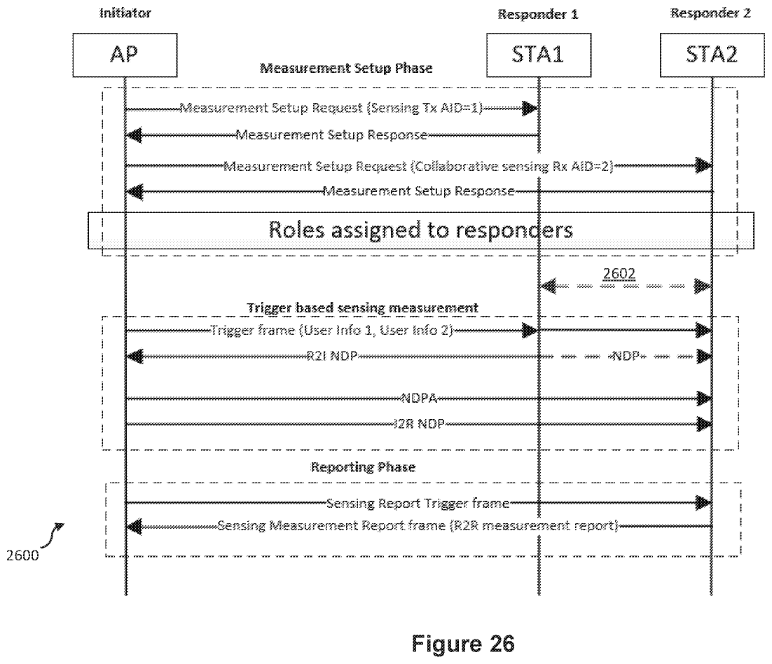

FIG. 26 depicts a diagram 2600 illustrating an example of Trigger-based collaborative sensing procedure with TB sensing measurement between a sensing initiator (AP) and two sensing responders (STA1, STA2) according to the first embodiment of present disclosure. The procedure comprises a measurement setup phase, a trigger-based sensing measurement phase and a reporting phase. In this case, sensing responder STA1 is a sensing transmitter and sensing responder STA2 is a sensing receiver capable of collaborative sensing. During measurement setup phase, the AP transmits a Measurement Setup Request frame to the sensing transmitter STA1, and the STA1, in response, transmits a Measurement Setup Response frame to the AP. The AP then transmits another Measurement Setup Request frame with an indication to assign the sensing role to STA with, for example, AID 2 (in this case STA2), and the STA2, in response, transmits a Measurement Setup Response frame to the AP. With such steps, the roles are now assigned to the responder which can perform collaborative sensing (i.e., STA2). The STA1 and STA2 now have a collaborative sensing link 2602. In particular, the AP-STA1 link performs breathing rate estimation and the STA1-STA2 link 2602 performs presence detection.

During trigger-based sensing measurement phase, the sensing initiator (AP) first initiates the sensing measurement by transmitting a Trigger frame comprising two User Info fields carrying User Info 1 and User Info 2 for STA1 and STA2 respectively. The User Info 1 for STA1 carries an indication for UL transmission of NDP from the sensing responder (Tx), and the User Info 2 for STA2 carries a Special AID for the collaborative sensing. The STA2 can identify the TF based on the Special AID for STA2 and be notified by Tx parameters for NDP from another sensing responder, i.e., STA1, from the User Info field. The sensing responder (Tx), i.e., STA1, then transmits a R2I NDP back to the AP. With the role of a collaborative sensing receiver, sensing responder STA2 is also able to receive the NDP transmitted by the sensing transmitter STA1. Subsequently, the sensing initiator transmits a NDPA frame followed by a I2R NDP to the collaborative sensing receiver, and the measurement sensing phase may end.

During the Reporting phase, the sensing initiator transmits a Sensing Report Trigger frame to the collaborative sensing receiver STA2, and the STA2, in response, transmits a Sensing Measurement Report frame comprising a Responder to Responder (R2R) measurement report to the sensing initiator.

To achieve collaborative sensing, the collaborative sensing information transmitted in the User Info field of a Trigger frame needs to follow the following rules:
The collaborative sensing indication may be carried in a polling Trigger frame, a sounding Trigger frame or an NDPA frame;
The User Info field of the frame shall be prepared in a way that the AID is in sequential order;
The special AID is same for all the collaborative sensing capable receivers; and
The collaborative sensing receiver may identify the User Info based on the special AID.

In the following paragraphs, a second embodiment of the present disclosure where a non-TB Sounding procedure is used for collaborative sensing procedure is described.

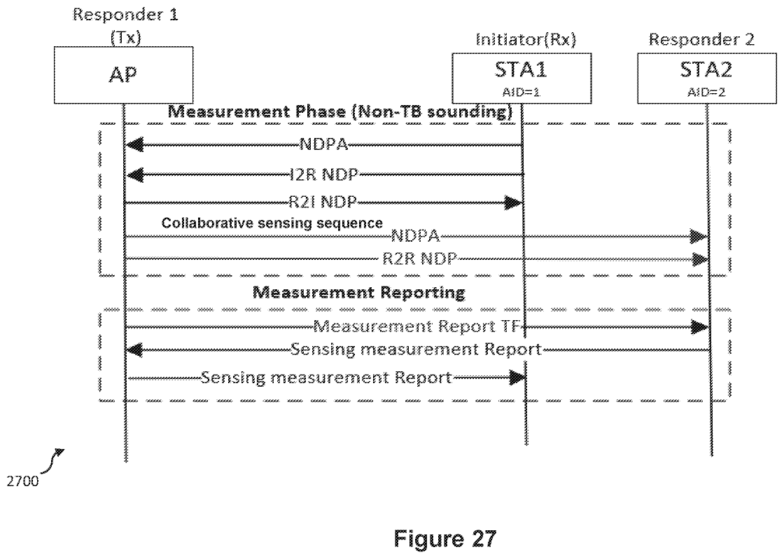

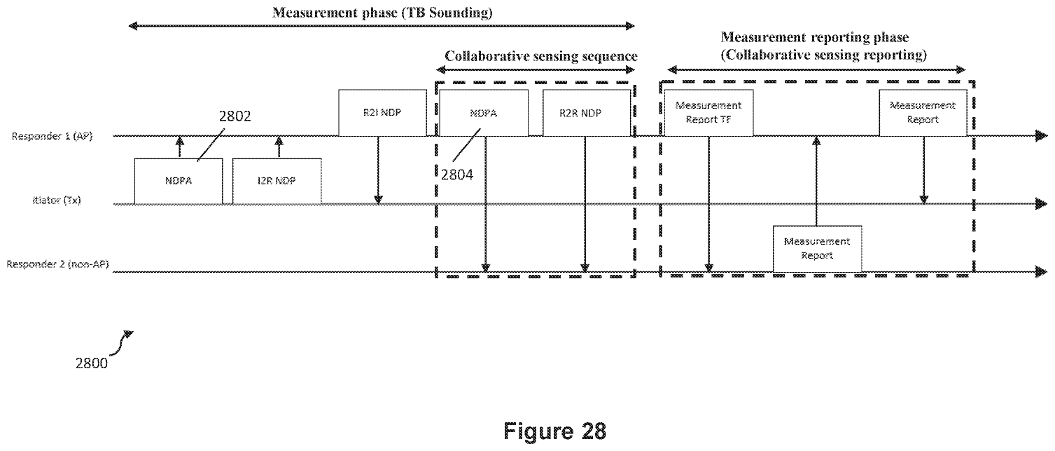

FIGS. 27 and 28 respectively depict a flowchart 2700, 2800 illustrating an example non-TB collaborative sensing procedure between a sensing initiator (initiator STA1) and two sensing responders (responder AP (responder 1), and responder STA2 (non-AP responder 2)) according to the second embodiment of the present disclosure. The procedure comprises a sensing measurement phase via a non-TB sounding procedure, a collaborative sensing sequence and a measurement reporting phase. In this case, sensing responder STA1 (e.g., AID=1) is a sensing initiator and a sensing transmitter, the responder AP is a sensing receiver, responder 2 is a collaborative sensing capable STA.

During the non-TB sounding sensing measurement phase, the sensing initiator (STA1) first initiates the sensing measurement by transmitting a NDPA frame 2802 following by a I2R NDP to the sensing responder AP. The NDPA frame configure the subsequent NDP transmitted by the sensing responder. The AP, in response, transmits a R2I NDP back to the STA1. Subsequently, after transmitting the R2I NDP to the sensing initiator, a collaborative sensing sequence is then carried out in addition to non-TB sequence to achieve collaborative sensing in non-TB sensing scenarios. As the AP is aware of the non-AP responder STA and its capability, this is a simple way to perform collaborative sensing in non-TB scenario.

In particular, in the collaborative sensing sequence, the responder AP transmits a NDPA frame 2804 and a R2R NDP to the non-AP responder to perform collaborative sensing.

During the reporting phase, the responder AP transmits a Measurement Report TF to the collaborative sensing receiver STA2, and the STA2, in response, transmits a Sensing Measurement Report frame comprising measurement result from R2R NDP for collaborative sensing to the responder AP, and the responder AP redirects the Sensing Measurement Report frame to the sensing initiator STA1, as all sensing measurement results shall be reported to the initiator.

The initiator STA may set the duration field of the NDPA frame 2802 according to equation (1).

$$Duration = Length\_I2R \_NDP + Length\_R2I \_NDP \qquad Equation ( 1 )$$

If the initiator in non-TB case configures the NDPA frame 2802 with duration field according to Equation (1), then the collaborative sensing receiver will be able to receive measurement frames from the AP. The measurement instance ID is also kept the same in collaborative sensing sequence and reporting sequence for initiator to know about the measurement result identity.

For a non-TB case, the RA of the NDPA frame NDPA frame 2802 is set as Responder AP's (responder 1's) MAC Address, which means Responder 2 will set its Network allocation vector (NAV) when it receives the NDPA frame from the Responder AP. To avoid this limitation, the RA of NDPA 2802 is set to broadcast and the duration field in NDPA 2802 is set based on equation 1. This will result in NAV getting finished after transmission on I2R NDP from the initiator and the responder 2 will be able to receive NDPA 2804 from the AP (Responder 1).

It is noted that the procedure described in FIG. 28 is similar to Sensing-by-Proxy (SBP) scenario, the non-AP initiator may act as SBP initiator and AP may act as an SBP responder. The AP (responder) performs sensing with another non-AP (responder) fulfilling collaborative sensing.

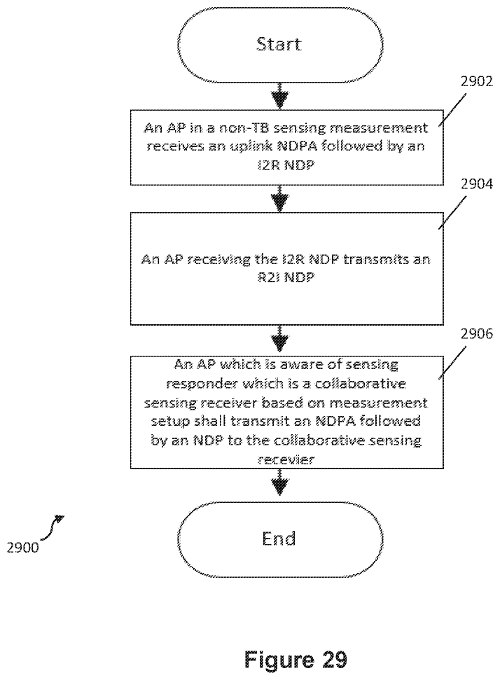

FIG. 29 depicts a flowchart 2900 illustrating a process implemented by an AP according to the second embodiment of the present disclosure. In step 2902, an AP in a non-TB sensing measurement receives an uplink NDPA frame followed by an I2R NDP. In step 2904, the AP receives the I2R NDP and transmits an R2I NDP. In step 2906, a step of transmitting, based on what the AP is aware of the sensing responder being a collaborative sensing receiver, an NDPA followed by an NDP to the collaborative sensing receiver.

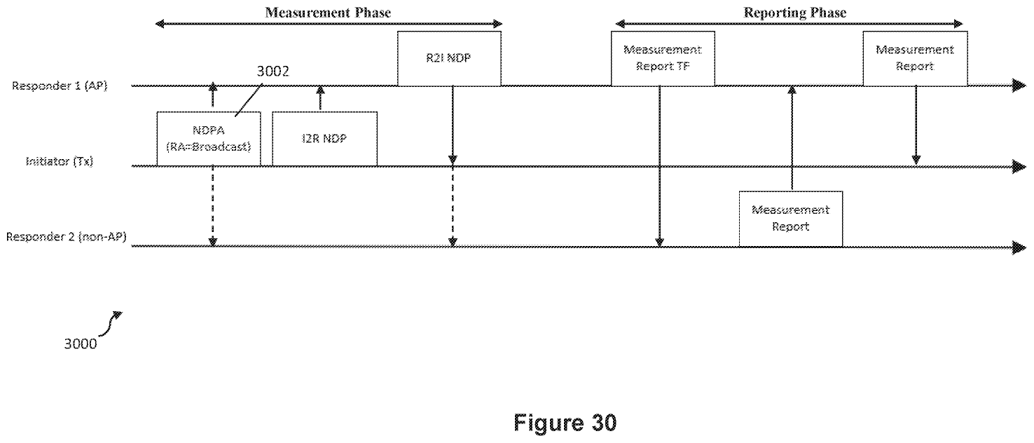

FIG. 30 depicts a diagram 3000 illustrating an example non-TB collaborative sensing procedure between a sensing initiator (initiator STA1) and two sensing responders (responder AP (responder 1), responder STA2 (non-AP responder 2)) according to an implementation of the second embodiment of the present disclosure.

In this implementation, the procedure comprises a measurement phase and a reporting phase. The sensing initiator then transmits the NDPA frame 3002 to both sensing responder AP and sensing responder STA2, followed by an I2R NDP to the sensing responder AP. The frame format of NDPA frame 3002 remains similar to that described in FIG. 23.

The duration in the NDPA frame 3002 is set to only cover till end of the R2I NDP transmission from the responder AP to the sensing initiator (STA1), and the RA field of the NDPA frame 3002 is set to broadcast (the RA rule is relaxed) and the NDPA frame 3002 itself comprises collaborative sensing information which assigns the sensing role to the sensing responder STA2. With such steps, the roles are now assigned to the responder STA2 which can perform collaborative sensing.

The sensing transmitter (AP) then transmits a R2I NDP to the sensing initiator. With the collaborative sensing role, STA2 is able to receive the NDP transmitted by the sensing transmitter.

During the reporting phase, the responder AP transmits a Measurement Report TF to the collaborative sensing receiver STA2, and the STA2, in response, transmits a Sensing Measurement Report frame comprising measurement result of R2R collaborative sensing to the responder AP, and the responder AP redirects the Sensing Measurement Report frame to the sensing initiator STA1.

To achieve this implementation, during the measurement setup phase, the non-AP initiator STA1 will be Tunnelled Direct Link Setup (TDLS) initiator and initiates a TDLS discovery. The non-AP TDLS responder (e.g., STA2) shall set frame filtering such that it can accept frames from the TDLS initiator. This enables the non-AP responder STA2 to accept NDPA frame 3002 from the non-AP initiator STA1 directly and perform collaborative sensing on the R2I NDP received from the sensing transmitter (AP).

Regarding frame filtering where a non-AP responder can receive frames from another non-AP STA (without TDLS), the collaborative sensing receiver receiving an NDPA frame for which the RA field is set to broadcast shall ignore the TA field if the User Info field carries special AID or collaborative sensing receiver indication in the User Info field. This will then allow collaborative sensing receiver to receive collaborative sensing indication from the non-AP sensing initiator to receive and decode subsequent sensing NDP.

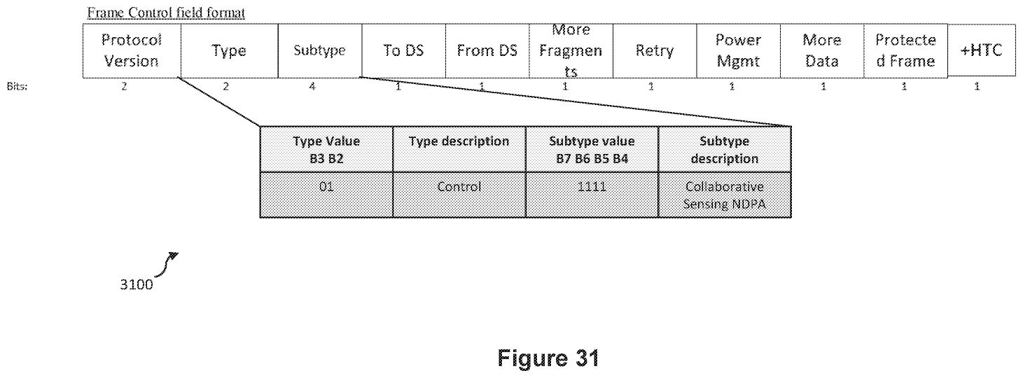

FIG. 31 depicts an example format of a Frame Control field 3100 of a NDPA frame according to an alternative implementation of the second embodiment of the present disclosure. The Frame Control field 3100 comprises a Protocol Version subfield, a Type subfield, a Subtype subfield, a To DS subfield, a From Distribution System (DS) subfield, a More Fragments subfield, a Retry subfield, a Power Management subfield, a More Data subfield, a Protected Frame subfield and a high throughput control (+HTC) subfield.

In this alternative implementation, an NDPA frame transmitted by a non-AP STA, which may also be received by a collaborative receiver, shall set its Protocol Version subfield to “02” for sensing. The Type subfield is set to “01” for control and the Subtype subfield is set to “1111” for collaborative sensing NDPA. It the NDPA frame is transmitted with the Frame Control field set according to FIG. 31, the non-AP STA receiving the frame will ignore the TA field and decode the NDPA frame to decode the subsequent NDP for channel measurement.

In the following paragraphs, a third embodiment of the present disclosure where a Tunneled Direct Link Setup (TDLS) link between non-AP STAs is formed prior to a non-TB sensing measurement instance is described.

In non-TB sensing scenario for collaborative sensing, a sensing initiator (non-AP STA) may not know about another non-AP sensing responder. This issue could be solved effectively by setting up a TDLS link between the non-AP STAs which are capable of collaborative sensing prior to a non-TB sensing measurement instance.

TDLS Discovery request/response frame exchange may take place before sensing measurement setup to ensure that the sensing transmitter and collaborative sensing receiver are in range of each other. If this frame exchange is successful, the collaborative sensing capable STA may be assigned the collaborative sensing receiver role.

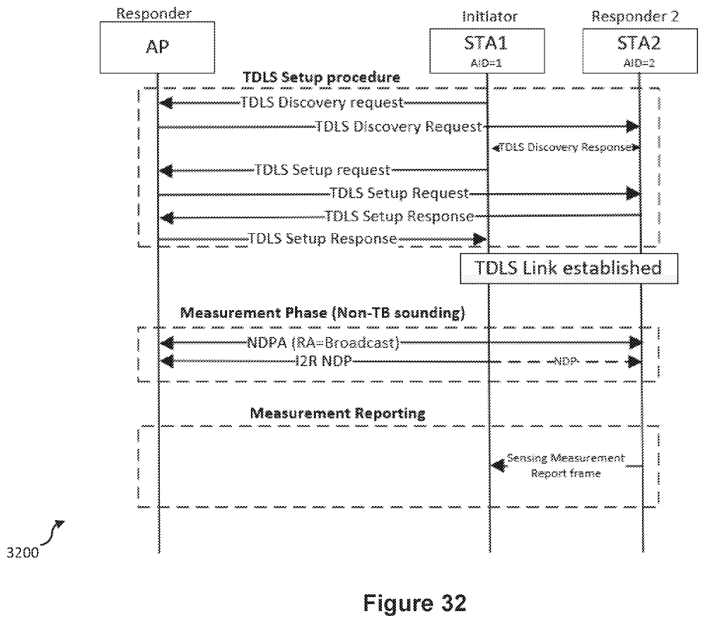

FIG. 32 depicts a flowchart 3200 illustrating an example non-TB sensing measurement between a sensing initiator (STA1) and two sensing responders (responder AP (responder 1), responder STA2 (non-AP responder 2)) according to the third embodiment of the present disclosure.

The procedure comprises a TDLS Setup procedure, a measurement phase via a non-TB sounding procedure and a measurement reporting phase. In this case, the STA1 is a sensing initiator, the AP and the STA2 are sensing responders.

In this case, the sensing initiator wishes to perform sensing measurement with the AP. Prior to measurement phase, a TDLS Setup procedure is carried out. The STA1 first transmits a TDLS Discovery Request frame to the AP and the AP directs the TDLS Discovery Request frame to the STA2. The STA2, in response, transmits a TDLS Discovery Request frame to the STA1. Subsequently, the STA1 transmits a TDLS Setup Request frame to the AP and the AP directs the TDLS Setup Request frame to the STA2. The STA2, which agrees to form a TDLS link with the STA1, will then transmits a TDLS Setup Response frame to the AP and the AP directs the TDLS Setup Response frame to the STA1, and the TDLS link between STA1 and STA2 is established. This enables transmission between the two non-AP STAs.

During measurement setup phase, the initiator (STA1) transmits a NDPA frame. The RA field of the NDPA frame is set to broadcast so that it is received on all links and the User Info field of the NDPA frame provides details of the TDLS recipient (STA2) so that TDLS recipient is notified about the subsequent NDP it may receive (similar to assigning a collaborative sensing role). STA1 then transmits a I2R NDP to the sensing responder AP to perform channel measurement. As the STA2 was notified about the NDP, STA2 is able to receive the NDP transmitted by STA1 directly on the TDLS link.

Lastly, during reporting phase, the sensing responder STA2 can transmit a Sensing Measurement Report to the sensing initiator STA1 directly on the TDLS link.

It is noted that the third embodiment of the present disclosure may not be a direct case of collaborative sensing, as collaborative sensing enables sensing between 2 responders. However, the third embodiment provides diversity in channel measurement where two non-AP STAs can perform sensing when a non-AP STA is a sensing responder.

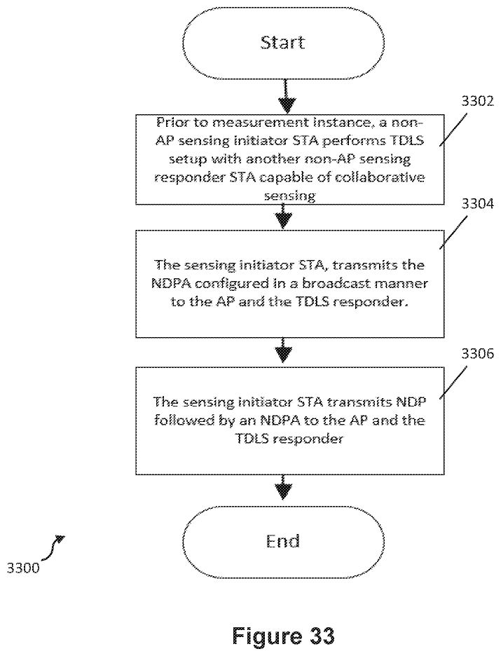

FIG. 33 depicts a flowchart 3300 illustrating a process implemented by a non-AP sensing initiator STA according to the third embodiment of the present disclosure. In step 3302, prior to a measurement instance, the non-AP sensing initiator STA performs a TDLS setup with another non-AP sensing responder STA capable of collaborative sensing. In step 3304, a step of transmitting the NDPA frame configured in a broadcast manner to the AP and the TDLS responder is carried out. In step 3306, a step of transmitting a NDP followed by the NDPA frame to the AP and the TDLS responder is carried out.

In the following paragraphs, a fourth embodiment of the present disclosure where a grouping of collaborative sensing capable STAs is implemented for performing collaborative sensing is described.

Collaborative sensing can be achieved by performing grouping during sensing session setup phase. Grouping is performed by assigning the collaborative sensing STAs a group ID to identify which collaborative sensing group are they part of. Such group IDs are assigned by the AP to the collaborative sensing capable responders which have similar RSSI of the received frames at the AP from the responder.

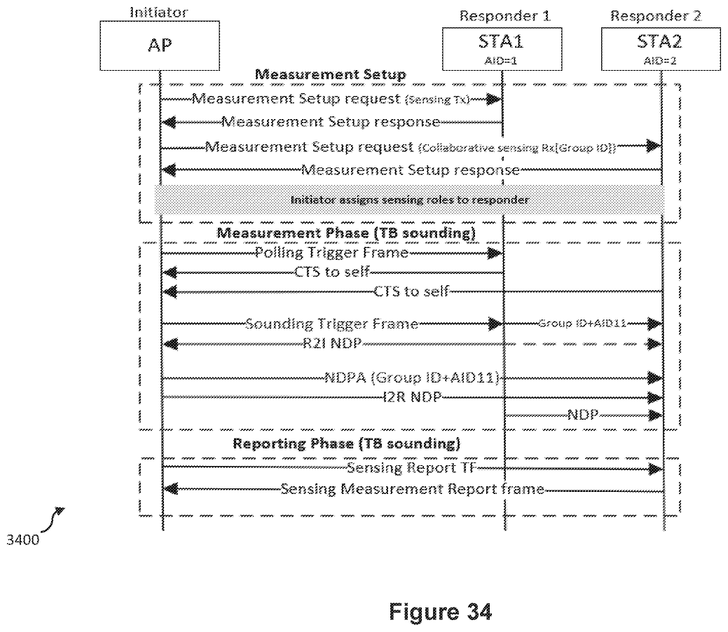

FIG. 34 depicts a flowchart 3400 illustrating an example TB collaborative sensing procedure between a sensing initiator (AP) and two sensing responders (STA1, STA2) according to the fourth embodiment of the present disclosure. The procedure comprises a measurement setup phase and a sensing measurement phase via a TB sounding procedure and a reporting phase via a TB sounding procedure. In this case, sensing responder STA1 (e.g., AID=1) is a sensing transmitter and sensing responder STA2 (e.g., AID=2) is a sensing receiver (capable of collaborative sensing). During measurement setup phase, the initiator first transmits a Measurement Setup Request frame to the sensing transmitter STA1, and the STA1, in response, transmits a Measurement Setup Response frame to the AP. The AP then transmits another Measurement Setup Request frame with an indication to assign the sensing role and a group ID to the STA2. The STA2 will identify which collaborative sensing group it is part of based on the group ID, and transmits a Measurement Setup Response frame to the AP. With such steps, the roles are now assigned to the STA2. In one embodiment, the Measurement Setup Request frame and Measurement Setup Response frame exchanged between STAs to perform the sensing measurement setup are protected Sensing Session Setup request and response frames.

During sensing measurement phase, a TB sounding procedure is carried out where the sensing initiator (AP) first initiates the sensing measurement by transmitting a Polling TF to one or more STAs that are assigned to be polled in the TB sensing measurement instance and expected to participate during the available period (in this case, both STA1 and STA2). The polling TF is used to check availability of the responder STAs and to allocate resources for transmission. The STA1 and STA2 each, in response to the Polling TF, transmits a CTS to self-frame to the AP to indicate that it is available for TB sensing.

Next, during the TF sounding phase, the AP then transmits a Sounding Trigger frame to solicit NDP transmissions (R2I NDP) from one or more STAs (in this case, STA1) to perform channel measurement, the Sounding TF carrying User Info field for STAs participating in sensing and User Info for collaborative sensing receiver comprising a group ID, the AID (in this case AID11) and parameters for responder to correctly decode subsequent NDP(s). The STA2 can identify the User Info field carrying the Group ID and the AID11 field address to its own Group ID and AID and obtain the collaborative sensing information from the User Info field.

As such, both STA1 and STA2 receive the Sounding TF. The STA1, in response, transmits a R2I NDP comprising a feedback response to the AP. With the collaborative sensing receiver role assigned and NDP information which may be received from another responder, the STA2 is able to receive the NDP transmitted by the STA1 too.

The AP transmits a NDPA frame to the sensing responder which is a sensing receiver (in this case, STA2) followed by a I2R NDP to the STA2. The NDPA frame carries User (STA) Info field for STAs participating in sensing and User Info for collaborative sensing receiver comprising the group ID for responder to correctly decode subsequent NDP(s). Similarly, the STA2 can identify the User Info field carrying the Special AID and AID11 subfield address to its own AID and the Group ID subfield addressed to the collaborative sensing receiver group to which the STA2 belongs and obtain the collaborative sensing information from the User Info field. Subsequently, the STA1 transmitter then transmits a NDP to the collaborative sensing receiver STA2.

During the reporting phase, a TB sounding procedure is carried out where the AP solicits R2R sensing measurement report by transmitting a Sensing Report TF to the STA2 and the STA2, in response, transmits a Sensing Measurement Report frame comprising the sensing measurement result (e.g., R2R measurement report) to the AP.

The sensing initiator transmits a Sensing Report Trigger frame to the collaborative sensing receiver STA2, and the STA2, in response, transmits a Sensing Measurement Report frame comprising a Responder to Responder (R2R) measurement report to the sensing initiator.

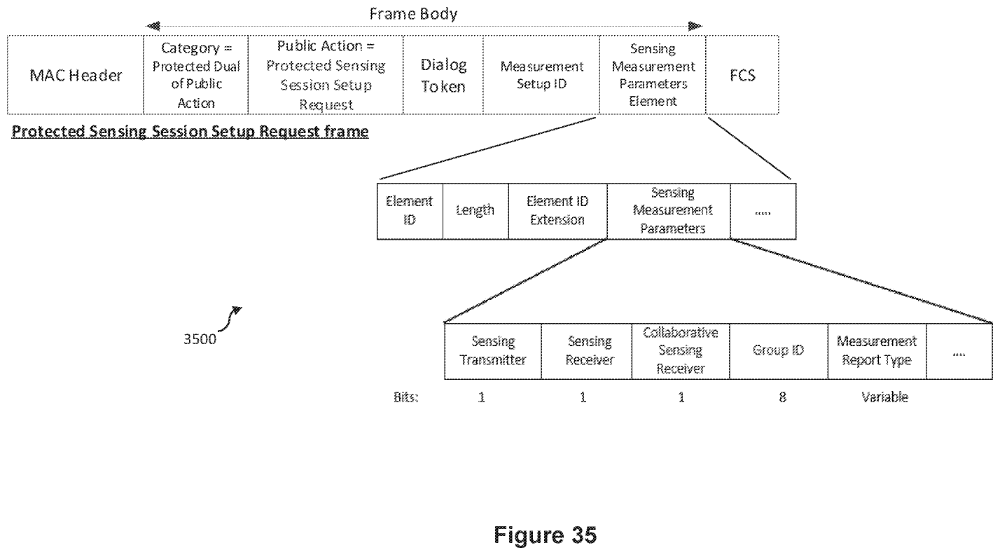

FIG. 35 depicts an example protected Sensing Session Setup Request frame 3500 according to the fourth embodiment of the present disclosure. The protected Sensing Session Setup Request frame 3500 comprises a MAC Header (Frame Control field, Duration field, RA field and TA field), a Category field, a Public Action field, a Dialog Token field, a Measurement ID field, a Sensing Measurement Parameters Element field and a frame checking sequence (FCS) field. The Category field is set to “Protected Dual of Public Action” and the Public Action field is set to “Protected Sensing Session Setup Request”. The Sensing Measurement Parameter Element field comprises an Element ID subfield, a Length subfield, an Element ID Extension subfield, a Sensing Measurement Parameters subfield. The Measurement Setup ID field carries a measurement ID being negotiated between the two STAs.

The Sensing Measurement Parameters subfield carries the parameters related to the sensing measurement setup like sensing types and types of measurement reports (e.g., channel state information (CSI), partial CSI, etc.) and a group ID according to this embodiment, which comprises a Sensing Transmitter subfield, a Sensing Receiver subfield, a Collaborative Sensing Receiver subfield, a Group ID subfield and a Measurement Report Type subfield. The Collaborative Sensing Receiver subfield is set to 1 to indicate an assignment of a collaborative sensing receiver role to a collaborative sensing capable STA. The Group ID indicates the group ID identifying a group of collaborative sensing capable STAs to assign the collaborative sensing role to such group of collaborative sensing capable STAs.

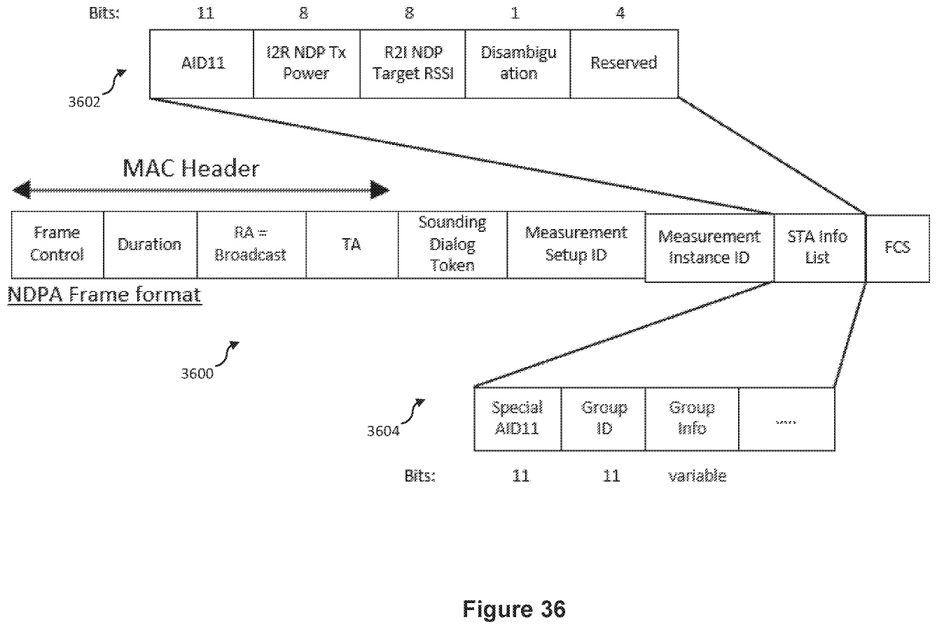

FIG. 36 depicts an example format of an NDPA frame 3600 according to the fourth embodiment of the present disclosure. The NDPA frame 3600 comprises a Frame Control field, a Duration field, a RA field, a TA field, a Sounding Dialog Token field, a Measurement Setup ID field, a Measurement Instance ID field, a STA Info List field and an FCS field. The Frame Control field, the Duration field, the RA field, and the TA field may be grouped as MAC header. The RA field is set to “Broadcast”. For collaborative sensing purpose, the STA Info List field comprises two different STA Info fields, one STA Info field 3602 for sensing transmitter (e.g., STA1 of FIG. 34) and another STA Info field 3604 for collaborative sensing receiver (e.g., STA2 of FIG. 34). The STA Info field 3602 comprises a AID11 subfield, a I2R NDP Tx Power subfield, a R2I NDP Target RSSI subfield and a Disambiguation subfield. The other STA Info field 3604 comprises a Special AID11 subfield (for collaborative sensing receiver), a Group ID subfield and a Group Info subfield.

The Special ID11 subfield enables a collaborative sensing capable STA to identify the STA Info field and the Group ID subfield enables a group of collaborative sensing capable STAs with the Group ID to receive information about the collaborative sensing parameters contained in the Group Info subfield to perform collaborative sensing.

In the following paragraphs, a fifth embodiment of the present disclosure where a collaborative sensing measurement with a collaborative sensing transmitter is described.

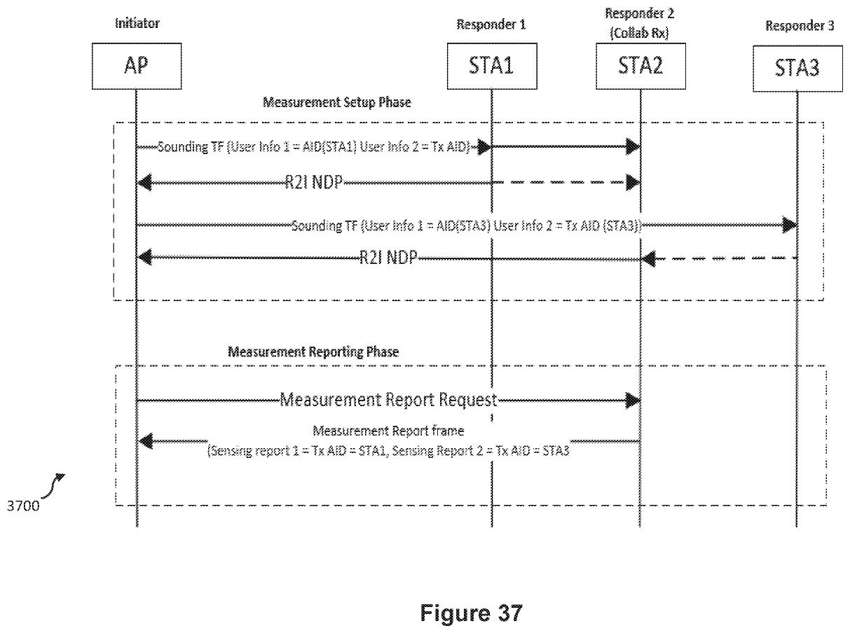

FIG. 37 depicts a flowchart 3700 illustrating an example collaborative sensing procedure between a sensing initiator (AP) and three sensing responders (STA1, STA2, STA3) according to the fifth embodiment of the present disclosure. The procedure comprises a measurement setup phase and a measurement reporting phase. In this case, the AP is a sensing initiator, sensing responder STA2 is a sensing receiver (capable of collaborative sensing) and sensing responders STA1 and STA3 are collaborative sensing transmitters. During sensing measurement phase, the sensing initiator (AP) transmits a Sounding TF to solicit NDP transmissions (R2I NDP) STA1 to perform channel measurement, the Sounding TF carrying User Info field 1 addressed to a collaborative transmitter (in this case STA1) with the collaborative transmitter's AID (STA1's AID) and User Info field 2 for collaborative sensing receiver addressed to STA2 for the STA2 to correctly decode subsequent NDP(s). In particular, the User Info field 2 comprises the AID of the sensing transmitter (STA1) so that STA2 is notified by the parameters of the subsequent NDP it may receive from another responder (STA1).

The STA1, in response, transmits a R2I NDP comprising a feedback response to the AP. With the collaborative sensing receiver role assigned and NDP information which may be received from another responder, the STA2 is able to receive the NDP transmitted by the STA1 too.

Similarly, the sensing initiator then transmits a Sounding TF to solicit NDP transmissions (R2I NDP) STA3 to perform channel measurement, the Sounding TF carrying User Info field 1 addressed to a collaborative transmitter (in this case STA3) with the collaborative transmitter's AID (STA3's AID) and User Info field 2 for collaborative sensing receiver addressed to STA2 for the STA2 to correctly decode subsequent NDP(s). In particular, the User Info field 2 comprises the AID of the sensing transmitter (STA3) so that STA2 is notified by the collaborative sensing receiver information about the subsequent NDP it may receive from another responder (STA3).

The STA3, in response, transmits a R2I NDP comprising a feedback response to the AP. With the collaborative sensing receiver role assigned and NDP information which may be received from another responder, the STA2 is able to receive the NDP transmitted by the STA3 too.

During the measurement reporting phase, the AP solicits R2R sensing measurement report by transmitting a Sensing Report TF to the STA2 and the STA2, in response, transmits a Sensing Measurement Report frame comprising the sensing measurement report 1 and sensing report 2 to the AP. The sensing measurement reports 1 and 2 carry the respective collaborative sensing transmitter AIDs' (STA1's AID and STS3's AID) so that the initiator which receives the reports will know each report is for which collaborative sensing transmitter-receiver pair.

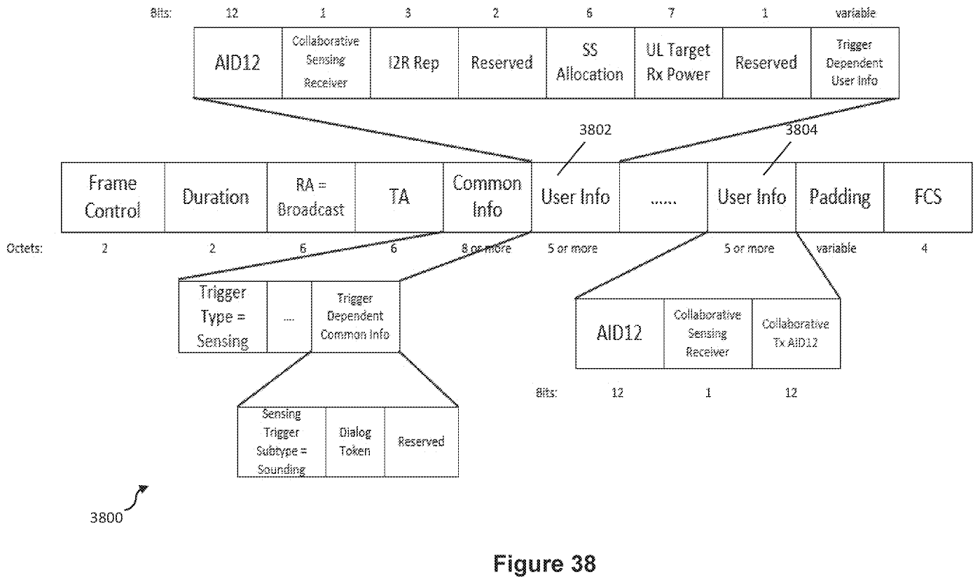

FIG. 38 depicts another example format of a sounding TF 3800 according to the fifth embodiment of the present disclosure. The sounding TF 3800 comprises a Frame Control field, a Duration field, a Recipient field set to “broadcast”, a Transmitter field, a Common Info field, one or more User Info field, a Padding field and an FCS field. The Common Info field comprises a Trigger Type subfield set to “Sensing” and a Trigger Dependent Common Info subfield. The Trigger Dependent Common Info subfield comprises a Sensing Trigger Subtype set to “Sounding” and a Dialog Token field. For collaborative sensing purpose, the sounding TF 3800 comprises two different User Info fields 3802, 3804, one User Info field 3802 for Sensing transmitter (e.g., STA1 and STA3 of FIG. 37) and another User Info field 3804 for collaborative sensing receiver (e.g., STA2 of FIG. 37). The User Info field 3804 for sensing transmitter comprises a AID12 subfield, a Collaborative Sensing Receiver subfield, I2R Rep subfield, a SS Allocation subfield, an UL Target Receive Power subfield and a Trigger Dependent User Info subfield. The other User Info field 3904 for collaborative sensing receiver comprises a AID12 subfield, a Collaborative Sensing Receiver subfield and a Collaborative Transmitter AID12 subfield. The Collaborative Transmitter AID12 subfield carries AID of the collaborative sensing transmitter. The Collaborative Transmitter AID12 subfield is an indication to the collaborative sensing receiver to follow the same transmit parameters as for the responder indicated in the User Info field (e.g., User Info field 3902) with the responder's AID12 subfield.

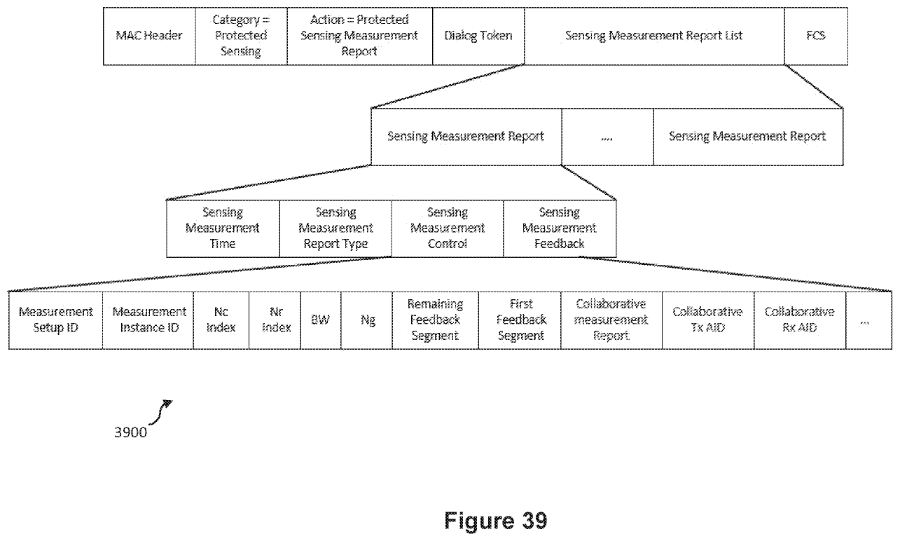

FIG. 39 depicts an example format of a Sensing Measurement Report frame 3900 according to the fifth embodiment of the present disclosure. The Sensing Measurement Report frame 3900 comprises a MAC header (Frame Control field, Duration field, RA field and TA field), a Category field, an Action field, a Dialog Token field, a Sensing Measurement Report List field and an FCS field. The Sensing Measurement Report List field carries one or more Sensing Measurement Report frames, each of which comprising a Sensing Measurement Time subfield, a Sensing Measurement Report Type subfield, a Sensing Measurement Control subfield and a Sensing Measurement Feedback subfield. The Sensing Measurement Control subfield comprises a Measurement Setup ID subfield, a Measurement Instance ID field, a No index field, a Nr index field, a BW field, a Ng field, a Remaining Feedback Segment field, a First Feedback Segment field, a Collaborative Measurement Report field, a Collaborative Tx AID field and a Collaborative Rx AID field. The Collaborative Tx AID field indicates the AID of the collaborative Tx to which the Sensing Measurement Report relates to. A sensing initiator can use this collaborative Tx AID field and collaborative Rx AID field to identify which collaborative sensing link the sensing measurement report is for.

In the following paragraphs, a sixth embodiment of the present disclosure where a sequence number is assigned to each NDP in the User Info field for collaborative sensing receiver to identify a sensing measurement report for the NDP is described.

In particular, it is possible that the AP assigns sequence number (SNs) to each R2R NDP in the User Info field for collaborative sensing receiver in a NDPA frame. This enables the sensing initiator to identify, during the sensing measurement, the sensing measurement is for which NDP by identifying the sequence number.

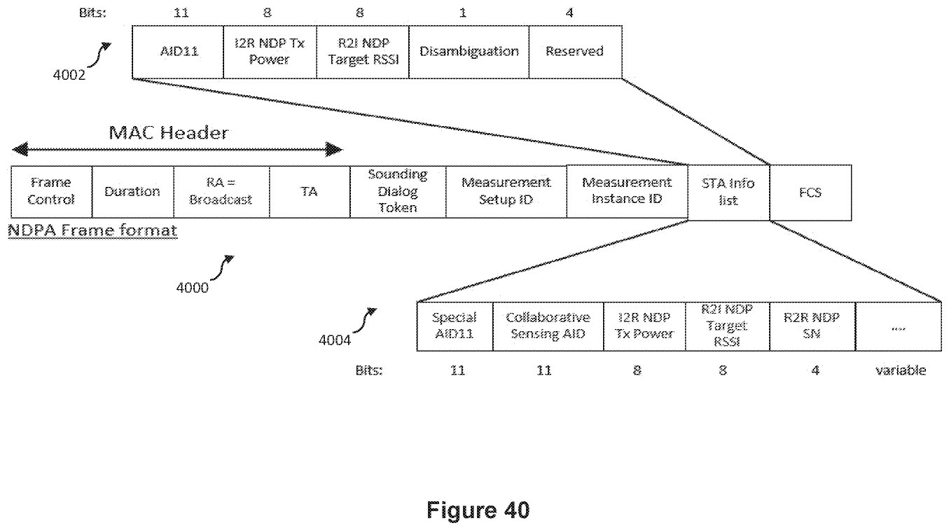

FIG. 40 depicts an example format of an NDPA frame 4000 according to the sixth embodiment of the present disclosure. The NDPA frame 4000 comprises a Frame Control field, a Duration field, a RA field, a TA field, a Sounding Dialog Token field, a Measurement Setup ID field, a Measurement Instance ID field, a STA Info List field and an FCS field. The Frame Control field, the Duration field, the RA field and the TA field may be grouped as MAC header. The RA field is set to “Broadcast”. For collaborative sensing purpose, the STA Info List field comprises two different STA Info fields, one STA Info field 4002 for sensing transmitter (e.g., STA1 of FIGS. 17 and 20) and another STA Info field 4004 for collaborative sensing receiver (e.g., STA2 of FIGS. 17 and 20). The STA Info field 4002 comprises a AID11 subfield, a I2R NDP Tx Power subfield, a R2I NDP Target RSSI subfield and a Disambiguation subfield. The other STA Info field 4004 comprises a Special AID11 subfield (for collaborative sensing receiver), a Collaborative Sensing AID subfield, a I2R NDP Tx Power subfield, a R2I NDP Target RSSI subfield and a R2R NDP SN subfield. The I2R NDP Tx Power subfield, the R2I NDP Target RSSI subfield and R2R NDP SN subfield correspond to the NDP Tx parameters NDP Tx parameters it may receive from another responder. The Collaborative Sensing AID is the associated ID of the collaborative sensing receiver. The R2R NDP SN subfield indicates a SN assigned to the R2R NDP. The receiver upon receiving the R2R NDP SN indication in the NDPA obtains the SN of the NDP which it will receive. The receiver may provide the same R2R NDP SN in the sensing measurement report for the initiator to know the sensing measurement report is for which R2R NDP based on the SN.

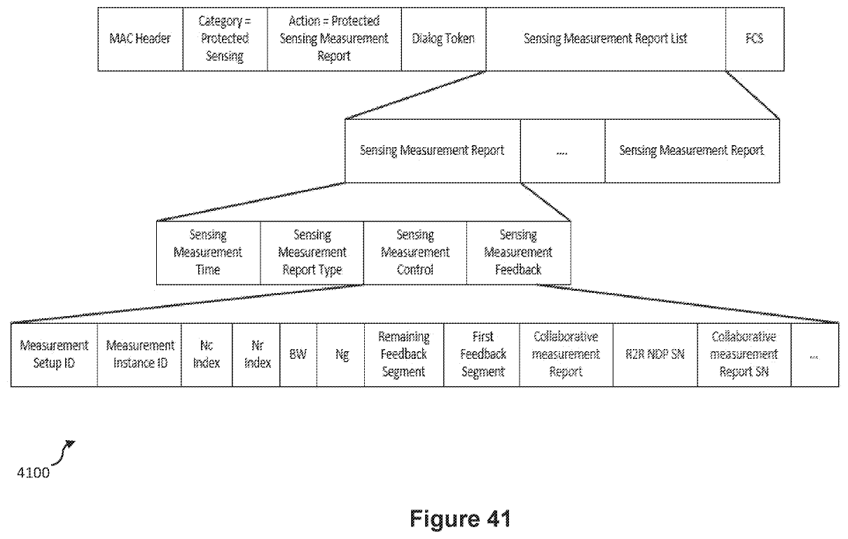

FIG. 41 depicts an example format of a Sensing Measurement Report frame 4100 according to the sixth embodiment of the present disclosure. The Sensing Measurement Report frame 4100 comprises a MAC header (Frame Control field, Duration field, RA field and TA field), a Category field, an Action field, a Dialog Token field, a Sensing Measurement Report List field and an FCS field. The Sensing Measurement Report List field carries one or more Sensing Measurement Report frames, each of which comprising a Sensing Measurement Time subfield, a Sensing Measurement Report Type subfield, a Sensing Measurement Control subfield and a Sensing Measurement Feedback subfield. The Sensing Measurement Control subfield comprises a Measurement Setup ID subfield, a Measurement Instance ID field, a Nc index field, a Nr index field, a BW field, a Ng field, a Remaining Feedback Segment field, a First Feedback Segment field, a Collaborative Measurement Report field, a R2R NDP SN field and a Collaborative Measurement Report SN field. The R2R NDP SN field is read by sensing initiator to identify the sensing measurement report is for which R2R NDP. In case of multiple receivers receiving the same NDP, the initiator can make use of the Collaborative Measurement Report SN subfield in the Sensing measurement report to differentiate the sensing measurement reports. The Collaborative Measurement Report SN will provide sequence number for the measurement report for the initiator to differentiate the sensing measurement reports.

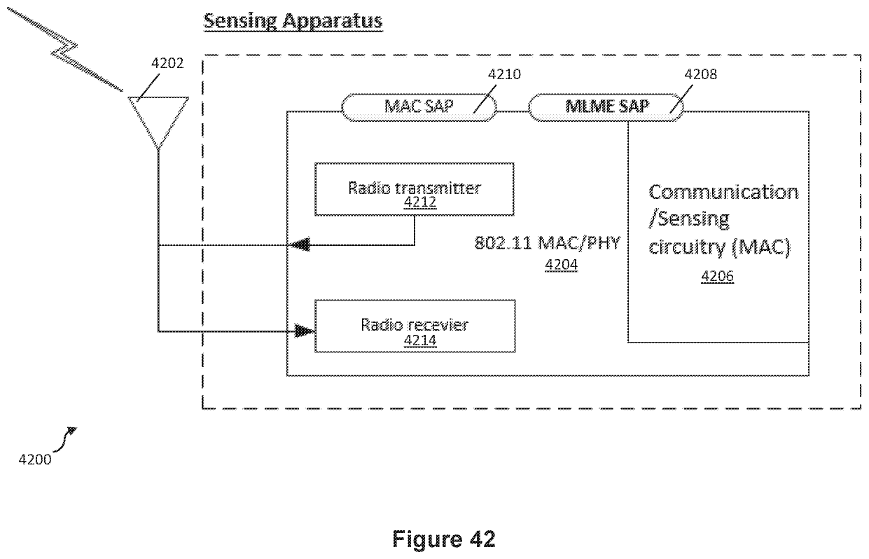

FIG. 42 depicts a block diagram 4200 illustrating a configuration of a communication apparatus which may be implemented as a receiving communication apparatus, a transmitting communication apparatus or an initiating communication apparatus, according to various embodiments of the present disclosure. Similar to the schematic example of communication apparatus 1200 shown in FIG. 11, the communication apparatus include at least antenna 4202 for transmission and receipt of signals (for the sake of simplicity, only one antenna is shown in FIG. 42), at least one radio transmitter 4212, at least one radio receiver 4214 and sensing circuitry 4206. The communication apparatus 4200 further comprises 802.11 MAC/PHY sublayers 4204 comprising a Sensing circuitry 4206 for channel measurements; layer management service interfaces such as MLME SAP 4208 and MAC SAP 4210 through which defined primitives are exchanged to pass information and layer management functions such as collaborative WLAN sensing may be invoked; and higher layer applications (e.g., WLAN Data Applications and WLAN Sensing Application) (not shown) communicating with the 802.11 MAC/PHY 4204 through MLME SAP 4208.

The at least one radio transmitter 4212, at least one radio receiver 4214, and sensing circuitry 4206 may respectively transmit, receive, generate/process signals to provide functions for collaborative WLAN sensing as described in various embodiments above in the present disclosure.

The MAC/PHY Sublayer 4204 may also be configured to unpack a signal, response or measurement PPDU, e.g., trigger frame, response frame, sounding PPDU or NDP or report frame received from another communication apparatus and pass the information related to the received signal, response or PPDU or to the Sensing circuitry 4206.

The Sensing circuitry 4206 further comprises a encode/decode module (not shown) configured to decode and encode information for collaborative WLAN sensing according to various embodiments above in the present disclosure.

The following embodiments have been described and illustrated in the present disclosure, namely:
1) A receiving communication apparatus, comprising: a receiver, which, in operation, receives, from a transmitting communication apparatus, a sounding signal, wherein the transmitting communication apparatus is configured to perform a first channel measurement with an initiating communication apparatus; and circuitry, which, in operation, is configured to perform a second channel measurement with the transmitting communication apparatus upon receiving the sounding signal.
2) The receiving communication apparatus of embodiment 1, wherein the sounding signal is received by the initiating communication apparatus, and comprises a result of the first channel measurement performed by the transmitting communication apparatus with the initiating communication apparatus.
3) The receiving communication apparatus of embodiment 1 or 2, wherein, prior to receiving the sounding signal, the receiver receives a request signal comprising a signal field for the receiving communication apparatus, the signal field comprising first information to perform the second channel measurement.
4) The receiving communication apparatus of embodiment 3, wherein the request signal comprises one of a Trigger frame and a null data packet (NDP) announcement (NDPA) frame, and the signal field is comprised on the one of the Trigger frame and the NDPA frame.
5) The receiving communication apparatus of embodiment 3 or 4, wherein the receiver, prior to receiving the request signal, further receives a setup signal to establish a direct link with the initiating communication apparatus, and the receiver, subsequent to receiving the request signal, further receives a second sounding signal from the initiating communication apparatus through the direct link; and the circuitry is configured to perform a third channel measurement with the initiating communication apparatus upon receiving the second sounding signal.
6) The receiving communication apparatus of embodiment 3 or 4, wherein, prior to receiving the request signal, the receiver further receives a setup signal from the initiating communication apparatus, the setup signal comprising second information to perform the second channel measurement.
7) The receiving communication apparatus of embodiment 6, wherein the second information comprises an identifier assigned to a plurality of communication apparatuses capable of performing the second channel measurement, the plurality of communication apparatuses comprising the receiving communication apparatus, the first information of the signal field comprising the second information and third information of a parameter used by the plurality of communication apparatuses to perform the second channel measurement.
8) The receiving communication apparatus of embodiment 3 or 4, wherein the first information of the signal field comprises an identifier of the transmitting communication apparatus, and the circuitry is configured to further generate a second sounding signal comprising the identifier and a result of the second channel measurement.
9) The receiving communication apparatus of embodiment 3 or 4, wherein the first information of the signal field of the request signal comprises a sequence number assigned to each sounding signal transmitted to/received from the transmitting communication apparatus and the circuitry is configured to further generate a second sounding signal comprising the sequence number and a result of the second channel measurement.
10) A transmitting communication apparatus, comprising: circuitry, which, in operation, is configured to perform a first channel measurement with an initiating communication apparatus and generate a sounding signal; and a transmitter, which, in operation, transmits the sounding signal to a receiving communication apparatus, wherein the receiving communication apparatus receives the sounding signal and performs a second channel measurement with the transmitting communication apparatus.
11) The transmitting communication apparatus of embodiment 10, further comprising: a receiver, which, in operation, receives a request signal comprising a signal field for the receiving communication apparatus, the signal field comprising first information to perform the second channel measurement, and the circuitry is configured to perform the first channel measurement with the initiating communication apparatus and generate the sounding signal upon receiving the request signal.
12) An initiating communication apparatus, comprising: circuitry, which, in operation, generate a request signal; and a transmitter, which, in operation, transmits the request signal to a transmitting communication apparatus, wherein the transmitting communication apparatus is configured to perform a first channel measurement with the initiating communication apparatus upon receiving the request signal and a receiving communication is configured to perform a second channel measurement with the transmitting communication apparatus upon receiving a sounding signal from the transmitting communication apparatus.
13) The initiating communication apparatus of embodiment 12, wherein the sounding signal comprises a result of the first channel measurement performed by the transmitting communication apparatus with the initiating communication apparatus.
14) The initiating communication apparatus of embodiment 12 or 13, wherein, the transmitter further transmits the request signal to the receiving communication apparatus, the request signal comprising a signal field for the receiving communication apparatus, the signal field comprising first information to perform the second channel measurement.
15) The initiating communication apparatus of any one of embodiments 12-14, wherein the request signal comprises one of a Trigger frame and a null data packet (NDP) announcement (NDPA) frame, and the signal field is comprised on the one of the Trigger frame and the NDPA frame.
16) The initiating communication apparatus of any one of embodiments 12-15, wherein the transmitter, prior to transmitting the request signal, further transmits a setup signal to establish a direct link with the receiving communication apparatus, and, the transmitter, subsequent to transmitting the request signal, further transmits a second sounding signal to the first communication apparatus through the direct link, wherein the first receiving communication apparatus is configured to perform a third channel measurement with the initiating communication apparatus upon receiving the second sounding signal.
17) The initiating communication apparatus of any one of embodiments 12-15, wherein, prior to receiving the request signal, the receiver further receives a setup signal from the initiating communication apparatus, the setup signal comprising second information to perform the second channel measurement.
18) The initiating communication apparatus of embodiment 17, wherein the second information comprises an identifier assigned to a plurality of communication apparatuses capable of performing the second channel measurement, the plurality of communication apparatuses comprising the receiving communication apparatus, the first information of the signal field comprising the second information and third information of a parameter used by the plurality of communication apparatuses to perform the second channel measurement.
19) A communication method implemented by a receiving communication apparatus, comprising: receiving, from a transmitting communication apparatus, a sounding signal, wherein the transmitting communication apparatus is configured to perform a first channel measurement with an initiating communication apparatus; and performing a second channel measurement with the transmitting communication apparatus based on the sounding signal.
20) A communication method implemented by a transmitting communication apparatus, comprising: performing a first channel measurement with an initiating communication apparatus and generate a sounding signal; and transmitting the sounding signal to a receiving communication apparatus, wherein the receiving communication apparatus receives the sounding signal and performs a second channel measurement with the transmitting communication apparatus.
21) A communication method implemented by an initiating communication apparatus, comprising: generating a request signal; and transmitting the request signal to a transmitting communication apparatus, wherein the transmitting communication apparatus is configured to perform a first channel measurement with the initiating communication apparatus upon receiving the request signal and a receiving communication apparatus is configured to perform a second channel measurement with the transmitting communication apparatus upon receiving a sounding signal from the transmitting communication apparatus.
   As described above, the embodiments of the present disclosure provide an advanced communication system, communication methods and communication apparatuses for an aggregated signal sounding procedure in MIMO WLAN networks and improve spectral efficiency in MIMO WLAN networks.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1.-20. (canceled)

21. A first sensing responder, comprising:
a receiver, which, in operation, receives a sounding Trigger frame from a sensing initiator; and
a transmitter, which, in operation, and in response to the sounding Trigger frame, transmits a Null Data Packet (NDP) to a second sensing responder.

22. The first sensing responder of claim 21, wherein the second sensing responder receives the sounding trigger frame from the sensing initiator.

23. The first sensing responder of claim 21, wherein the first sensing responder and the second sensing responder are non-access point stations and the sensing initiator is an access point.

24. The first sensing responder of claim 21, wherein:
the sensing initiator initiates a sensing procedure by transmitting a request frame, and the first sensing responder and the second sensing responder participate in the sensing procedure by responding to the sensing initiator;
the sensing procedure starts with a measurement setup phase, which is followed by a Trigger Based (TB) sensing measurement instance;
the TB sensing measurement instance includes a Polling phase, a NDPA sounding phase, a Trigger Frame (TF) sounding phase and a Reporting phase; and
the request frame is transmitted in the measurement setup phase and the sounding Trigger frame is transmitted in the TF sounding phase.

25. The first sensing responder of claim 24, wherein the sensing initiator assigns a role for each of the first sensing responder and the second sensing responder by transmitting the request frame in the measurement setup phase.

26. The first sensing responder of claim 25, wherein the role is one of a sensing receiver, a sensing transmitter, or a sensing transmitter and sensing receiver.

27. The first sensing responder of claim 24, wherein the request frame includes a Sensing Measurement Parameters Element, the Sensing Measurement Parameters Element including a Collaborative Sensing Receiver subfield which is set to 1 to indicate that the TB sensing measurement instance includes the transmission of the NDP from the first sensing responder to the second sensing responder.

28. The first sensing responder of claim 24, wherein the sensing initiator assigns a Measurement Setup ID to the first sensing responder and the second sensing responder by transmitting the request frame in the measurement setup phase, the Measurement Setup ID used to identify the measurement setup phase.

29. The first sensing responder of claim 28, wherein the sounding Trigger frame comprises a Measurement Setup ID field and a Measurement Instance ID field, the Measurement Setup ID field indicating the Measurement Setup ID, and the Measurement Instance ID field indicating a Measurement Instance ID which identifies the TB sensing measurement instance associated with the measurement setup phase.

30. The first sensing responder of claim 21, wherein the sounding Trigger frame comprises a Trigger Type subfield, the Trigger Type subfield being set to “Sensing”.

31. The first sensing responder of claim 21, wherein the sounding Trigger frame comprises a Trigger Dependent Common Info field, the Trigger Dependent Common Info field comprising a Sensing Trigger Subtype field, the Sensing Trigger Subtype field indicating a subtype of the sounding Trigger frame.

32. The first sensing responder of claim 21, wherein the sounding Trigger frame comprises a first User Info field for the first sensing responder and a second User Info field for the second sensing responder.

33. The first sensing responder of claim 32, wherein the first User Info field includes a first role field which indicates a role for the first sensing responder, and the second User Info field includes a second role field which indicates a role for the second sensing responder.

34. The first sensing responder of claim 33, wherein the second role field is set to 1 to indicate the role for the second sensing responder.

35. The first sensing responder of claim 21, wherein the sounding Trigger frame comprises a User Info field including an AID12 subfield set to 2008.

36. A communication method performed by a first sensing responder, comprising:
receiving a sounding Trigger frame from a sensing initiator; and
transmitting, in response to the sounding Trigger frame, a Null Data Packet (NDP) to a second sensing responder.

37. The communication method of claim 36, wherein the second sensing responder receives the sounding trigger frame from the sensing initiator.
